(19) United States
(12) Patent Application Publication
(10) Pub. No.: US 2026/0084728 A1
(43) Pub. Date: Mar. 26, 2026

(54) VEHICLE CONNECTION SYSTEM AND METHOD

(71) Applicant: Transportation IP Holdings, LLC, Norwalk, CT (US)

(72) Inventors: Aaron Nye, Erie, PA (US); Adam Franco, Erie, PA (US); Milan Karunaratne, Erie, PA (US)

(73) Assignee: Transportation IP Holdings, LLC, Norwalk, CT (US)

(21) Appl. No.: 18/893,809

(22) Filed: Sep. 23, 2024

(51) Int. Cl. B61G 5/08; B61G 7/06

(52) U.S. Cl. CPC B61G 5/08; B61G 7/06

(57) ABSTRACT

A system is provided for connecting a first hose of a first vehicle and a second hose of a second vehicle. The system may include a frame, a lacing actuator, first and second guides coupled to the frame, a first grasper, and a second grasper. The first guide may collect the first hose based on movement of the frame. The second guide may collect the second hose based on movement of the frame. The first grasper may receive the first hose from the first guide and deliver the first hose to the lacing actuator. The second grasper may receive the second hose from the second guide and deliver the second hose to the lacing actuator. The lacing actuator may position a first coupler of the first hose in engagement with a second coupler of the second hose.

### BACKGROUND

### Technical Field

The subject matter described herein relates to a system and a method for connecting vehicles, and in particular for manipulating hoses.

### Discussion of Art

Various vehicle systems may include multiple vehicles that are mechanically coupled together. For example, in the rail industry, multiple railcars may be coupled together to form a train. As another example, in the trucking industry, multiple trailers may be coupled together to form a long combination vehicle.

Coupling together multiple vehicles of a vehicle system may include coupling, connecting, or otherwise activating components of various subsystems. Suitable subsystems may include air handling systems, electrical systems, mechanical joints, and the like. For example, a vehicle system may employ an air brake subsystem. The air brake subsystem may include mateable air brake hoses that extend from the ends the vehicles of the vehicle system. To activate the air brake subsystem, air brake hoses for each set of coupled vehicles are connected to form a conduit that runs along the vehicle system. Thus, a fluid source of the air brake subsystem (e.g., a pneumatic air compressor) positioned on a vehicle of the vehicle system can supply compressed air for braking to multiple other vehicles of the vehicle system.

An air brake hose may be an approximately 3-foot long rubber hose with one end fastened to a vehicle's plumbed air-brake subsystem. (e.g., fastened an end of a railcar above and laterally offset from a mechanical coupler). An opposite end of the hose can include a coupler. The coupler (e.g., a gladhand) is designed to mate with and connect to a coupler from another vehicle's hose. The coupling action may be accomplished by physically aligning the couplers such that the hoses are approximately perpendicular, engaging the couplers, and turning (e.g., a 90 degree rotation) the couplers relative to each other such that the hoses align and the coupler components are connected to form the conduit for fluid communication. The process of connecting hoses is sometimes referred to as “lacing” or “hose lacing.” Hose lacing has been performed manually by a human operator. In the rail industry, a train can extend more than a mile long and include hundreds of rail cars. Having a human operator walk the entire length of the train and perform hose lacing at each of the coupled railcars can be a time-consuming, repetitive, and exhaustive process. It may be desirable to employ systems and methods for hose lacing that and differ from those that are currently available.

### BRIEF DESCRIPTION

In one or more embodiments, a system is provided for connecting a first hose of a first vehicle and a second hose of a second vehicle. The system includes a frame, a lacing actuator, a first guide coupled to the frame, a second guide coupled to the frame, a first grasper, and a second grasper. The first guide can collect the first hose based on movement of at least one of the frame, the first vehicle, or the first guide. The first grasper can receive the first hose from the first guide and deliver the first hose to the lacing actuator. The second guide can collect the second hose based on movement of at least one of the frame, the second vehicle, or the second guide. The second grasper can receive the second hose from the second guide and deliver the second hose to the lacing actuator. The lacing actuator can position a first coupler of the first hose in engagement with a second coupler of the second hose and can cause the first coupler and the second coupler to rotate relative to each other, thereby connecting the couplers.

In one or more embodiments, a method is provided for connecting hoses of a vehicle system. The vehicle system may include a first vehicle having a first hose and a second vehicle having a second hose. A first guide can move relative to the vehicle system in a first direction to funnel or otherwise lead the first hose of the first vehicle toward a first grasper and move a second guide relative to the vehicle system in a second direction different from the first direction to funnel or otherwise lead the second hose of the second vehicle toward a second grasper. The first grasper can deliver the first hose to a lacing actuator and the second grasper can deliver the second hose to the lacing actuator. The lacing actuator can position a first coupler of the first hose in engagement with a second coupler of the second hose.

### BRIEF DESCRIPTION OF THE DRAWINGS

FIG. 1 illustrates a schematic diagram of a system for connecting a first hose of a first vehicle and a second hose of a second vehicle, in accordance with at least one aspect of the disclosure.

FIGS. 2, 3, 4, 5, 6 and, 7 illustrate a process for connecting a first hose of a first vehicle and a second hose of a second vehicle using the system of FIG. 1, in accordance with at least one aspect of the disclosure.

FIG. 3A-3B illustrate an example grasper grasping a hose of a vehicle, in accordance with at least one aspect of the disclosure.

FIG. 5A illustrates an example lacing actuator, in accordance with at least one aspect of the disclosure.

FIGS. 7A-7C illustrates an example process for coupling a first gladhand of a first hose to a second gladhand of a second hose, in accordance with at least one aspect of the disclosure.

FIG. 8 illustrates a system that may travel along rails of a railway, in accordance with at least one aspect of the disclosure.

FIG. 9 illustrates a support structure, in accordance with at least one aspect of the disclosure.

FIG. 10 illustrates the support roller in a first position.

FIG. 11 illustrates an embodiment of the support roller in a second position.

FIG. 12 is a perspective view of a vehicle according to an embodiment of the invention.

FIG. 13 is a perspective view of a vehicle according to an embodiment of the invention.

FIG. 14 is a side view of the vehicle of FIG. 13.

FIG. 15 is a perspective view of one of a portion of the frame and one of the articulatable arms of the vehicle of FIG. 13.

FIG. 16 is a plan view of one of the articulatable arms of the vehicle of FIG. 13.

FIG. 17 is a plan view of one of the articulatable arms of the vehicle of FIG. 13.

FIG. 18 is a plan view of one of the articulatable arms of the vehicle of FIG. 13.

FIG. 19 is a plan view of the vehicle of FIG. 13.

FIG. 20 is a plan view of the vehicle of FIG. 13.

FIG. 21 is a perspective view of a portion of the vehicle of FIG. 13.

FIG. 22 is a side view of the vehicle of FIG. 21.

FIG. 23 is a plan view of FIG. 22.

FIG. 24 is a plan view of FIG. 22.

FIG. 25 is a plan view of FIG. 22.

FIG. 26 is a plan view of FIG. 22.

FIG. 27 is a schematic of a control circuit for an embodiment of a vehicle disclosed herein.

FIG. 28 is a perspective view of a vehicle according to an embodiment of the invention.

FIG. 29 is a perspective view of one of the actuatable arms of the vehicle of FIG. 28.

FIG. 30 is a front view of the actuatable arm of FIG. 29.

FIG. 31 is a plan view of the actuatable arm of FIG. 30.

FIG. 32 is a front view of the actuatable arm of FIG. 29.

FIG. 33 is a plan view of the actuatable arm of FIG. 32.

FIG. 34 is a front view of the actuatable arm of FIG. 29.

FIG. 35 is a plan view of the actuatable arm of FIG. 34.

FIG. 36 is a perspective view of the vehicle of FIG. 28.

FIG. 37 is a perspective view of the vehicle of FIG. 28.

### DETAILED DESCRIPTION

The subject matter disclosed herein relates to a system and a method for connecting hoses of a vehicle system. The vehicle system may include multiple vehicles couplable mechanically. An example vehicle system may be a train having multiple railcars. As another example, the vehicle system may be a long combination vehicle including a truck and a trailer. In some embodiments, the hoses may be hoses of an air brake system. In some embodiments, the hoses may be or otherwise include wires for transmitting an electrical current and/or signals. In some embodiments, the system and method may move relative to the vehicle system and effectuate connection of the hoses automatically. In some embodiments, a human operator may remotely control the vehicle system (e.g., via wireless communication), causing the system to move relative to the vehicle system and effectuate connection of the hoses. The system and method disclosed herein may therefore provide an alternative to labor-intensive hose lacing approaches that are carried out manually by a human operator.

In one embodiment, a vehicle connection system has a frame, a lacing actuator, a first guide, a second guide, a first grasper, and a second grasper. A control circuit may communicate with the components and initiate actuation or operation as described herein. The lacing actuator can position a first coupler of a first hose in engagement with a second coupler of a second hose. The first guide can be coupled to the frame and can collect the first hose responsive to movement of at least one of the frame, the first vehicle, or the first guide. Similarly, the second guide can be coupled to the frame and can collect the second hose responsive to movement of at least one of the frame, the second vehicle, or the second guide. The first grasper can receive the first hose from the first guide and deliver the first hose to the lacing actuator. The second grasper can receive the second hose from the second guide and deliver the second hose to the lacing actuator.

The lacing actuator may define a lacing actuator subsystem for positioning the first coupler of the first hose in engagement with the second coupler of the second hose and/or for coupling the first coupler and the second coupler. For example, the lacing actuator may be a lacing actuation subsystem that includes a component for positioning or otherwise maneuvering the first hose and a second component for positioning or otherwise maneuvering the second hose. In some embodiments, the lacing actuator can be coupled to the frame. In some embodiments, the lacing actuator may be coupled to the first grasper and/or the second grasper. For example, a component of lacing actuator may be coupled to the first grasper and a component of the lacing actuator may be coupled to the second grasper.

During operation, the system may connect a first hose of a first vehicle and a second hose of a second vehicle. The system may include a frame and a lacing actuator coupled to the frame. The lacing actuator may position the first coupler of the first hose in engagement with the second coupler of the second hose. In one example, the lacing actuator may couple the first coupler of the first hose and the second coupler of the second hose to define a conduit for conveying fluid between the first vehicle and the second vehicle. In another example, the lacing actuator may couple the first coupler of the first hose and the second coupler of the second hose to define a conduit for transmitting electric current and/or signals between the first vehicle and the second vehicle.

The first coupler of the first hose may include a first gladhand and the second coupler of the second hose may include a second gladhand. To couple the first gladhand the second gladhand, a first end portion of the first hose and a second end portion of the second hose the second hose are angled at approximately 90 degrees relative to each other and the first gladhand is engaged with the second gladhand. With the first gladhand is engaged with the second gladhand, the end portion of the first hose is aligned with the end portion of the second hose (e.g., by releasing the hoses and allowing the hoses to hang freely), causing relative rotation of the first gladhand and the second gladhand, thereby coupling of the first gladhand and the second gladhand.

The lacing actuator may manipulate the first hose and the second hose such that an end portion of the first hose is angled at approximately 90 degrees relative to an end portion of the second hose, allowing the first gladhand and the second gladhand operably engage one another. The lacing actuator may then cause the first and second gladhands to rotate relative to each other (e.g., approximately 90 degrees) to align the end portions of the hoses and effectuate the coupling of the gladhands to define the conduit for conveying fluid between the first vehicle and the second vehicle. In one example, the lacing actuator may be actuated to manipulate the end portions of the hoses to cause the first and second gladhands to rotate relative to each other. In another example, the lacing actuator may cause the first and second gladhands to rotate relative to each other by releasing the hoses, wherein gravity causes the ends of the hoses to align and rotate the gladhands as the hoses fall.

The lacing actuator may include various components for manipulating the first hose and the second hose. For example, the lacing actuator may define a lacing actuation subsystem including a plurality of components.

In some embodiments, the lacing actuator may include a robotic arm having an end effector configured to grasp and manipulate a hose.

In some embodiments, the lacing actuator may include multiple linear actuators and/or rotatory actuators to manipulate a position of a hose coupler, for example, such that the coupler is in proper lacing alignment with the coupler of another hose, and further manipulate the hose to cause engagement of the couplers.

In some embodiments, the lacing actuator may include a first coupler holder, a second coupler holder, a first hose manipulator, and a second hose manipulator. The first coupler holder can grasp and/or otherwise maneuver the first coupler of the first hose and the second coupler holder can grasp and/or maneuver the second coupler of the second hose to enable engagement of the first coupler and the second coupler. The first hose manipular can manipulate (e.g., kink, bend) the first hose and the second hose manipulator can manipulate (e.g., kink, bend) the second hose, for example, to cause the first coupler and the second coupler (e.g., first and second gladhands) to rotate relative to each other.

In some embodiments, the lacing actuator may include a hose funneling mechanism to bring the hose to a specific location. The lacing actuator may include a mechanism to secure the hoses together (e.g., with a zip tie, with tape to avoid unintended breaks a conduit defined by the hoses).

The system may include a first guide coupled to the frame and a second guide couple to the frame. Each of the first guide and the second guide may collect a respective one of the first hose and second air based at least in part on relative movement of the respective first and second guides, the frame, the first vehicle, and/or the second vehicle. For example, the first guide may have a set of first arms. In some embodiments, the first arms may be fixed relative to the frame. As the frame moves relative to the first vehicle or as the first vehicle moves relative to the frame, the first arms of the first guide may lead, funnel or otherwise collect the first hose (e.g., as it dangles from the first vehicle). Additionally, the second guide may have a set of second arms. The second arms may be fixed relative to the frame. As the frame moves relative to the second vehicle or as the second vehicle moves relative to the frame, the second arms of the second guide may lead, funnel or otherwise collect the second hose (e.g., as it dangles from the second vehicle). In some embodiments, the first guide and/or the second guide may move relative the frame to actively lead the first hose and second hose to the first grasper and the second grasper, respectively.

The system may include a first grasper and a second grasper. The first grasper may receive the first hose from the first guide and deliver the first hose to the lacing actuator. The second grasper may receive the second hose from the second guide and deliver the second hose to the lacing actuator.

In some embodiments, the first grasper and/or the second grasper can include a catch (e.g., a u-shaped catch), a clamp (e.g., a c-shaped clamp), fixed jaws, and/or actuatable jaws to grasp the first hose and/or the second hose. For example, the first hose may include an outer diameter. The first coupler of the first hose may have a profile that is wider than the outer diameter. The first grasper may include an inner portion that is sized to compliment and fit around the outer diameter of the first hose. However, the inner portion of the first grasper may be sized to be smaller than the profile of the first coupler such that the first coupler cannot slide through the inner portion of the first grasper, thereby causing the first grasper to grasp the first hose when impeded by the first coupler.

The system may define a first movement area (e.g. track) and a movement area (e.g., a second track). The first grasper may be movable along the first movement area. The first guide may lead or otherwise funnel the first hose to a first position along the first movement area. The first grasper may be located at the first position such that the first guide leads or otherwise funnels the first hose to the first grasper. The first grasper may grasp the first hose, for example, by actuating the second grasper to open and/or close an end of the second grasper (e.g., an actuatable jaw). While grasping the first hose, the first grasper may move along the first movement area from the first position to a third position along the first movement area. The lacing actuator may be located at the third position, thus resulting in the first grasper delivering the first hose to the lacing actuator. The first grasper may comprise a motor or another means of propelling the first grasper along the first movement area. Additionally, or alternatively, first grasper may move along the first movement area based at least in part on motion of the frame relative to the first vehicle (e.g., based on tension caused by the first grasper grasping the first hose attached to the first vehicle while the frame moves relative to the first vehicle).

The second grasper may be movable along the second movement area. The second guide may lead or otherwise funnel the second hose to a second position along the second movement area. The second grasper may be located at the second position such that the second guide leads or otherwise funnels the second hose to the second grasper. The second grasper may grasp the second hose for example, by actuating the second grasper to open and/or close an end of the second grasper (e.g., an actuatable jaw). While grasping the second hose, the second grasper may move along the second movement area from the second position to a fourth position along the second movement area. The fourth position may be longitudinally aligned with the third position along the first movement area, as noted above. The lacing actuator may be located at the fourth position, thus resulting in the second grasper delivering the second hose to the lacing actuator. The second grasper may comprise a motor or another means of propelling the second grasper along the second track. Additionally, or alternatively, second grasper may move along the second movement area based at least in part on motion of the frame relative to the second vehicle (e.g., based on tension caused by the second grasper grasping the second hose attached to the second vehicle while the frame moves relative to the second vehicle). In one embodiment, the first and second graspers are arranged in opposite directions relative to each other.

In some embodiments, the first movement area may include a first track and the second movement area may include a second track. The first track and the second track may be laterally offset from one another. For example, the frame can define a longitudinal axis of the system. The first track may be on a first side of the longitudinal axis and the second track may be on a second side of the longitudinal axis.

The system may include one or more sensor selected based on the use requirements. Suitable sensors may include a camera, proximity sensor, ultrasonic sensor, magnetic sensor, and conductivity sensor. Other suitable sensors may include location or positioning sensors (e.g., a GPS circuit), impact sensors, range finders, lidar, and the like. Yet other suitable sensors may include a leak detection sensor, a microphone, an optical sensor, a temperature sensor, a pressure sensor, and a gas sensor.

A suitable grasping sensor may detect that the first hose is received by first grasper and/or that the second hose is received by the second grasper. For example, the grasping sensor may detect that the first hose has been delivered to the first grasper by the first guide and is proximate to the first grasper (e.g., positioned between jaws of the first grasper, captured by jaws of the first grasper). A suitable grasping sensor may one or more camera, proximity sensor, ultrasonic sensor, magnetic sensor, or conductivity sensor. Other sensors may be selected with reference to the end use application. If the grasping sensor fails to detect receipt of a hose by the grasper, the control circuit may initiate a repeat of the grasping step, may signal for aid to be dispatched, may initiate a remediation routine, may collect and send information about the situation, may perform a function check, or may respond in another manner selected with reference to the equipment and a determined operating plan.

The system may include at least one lacing sensor. The lacing sensor may detect engagement of the first coupler of the first hose with the second coupler of the second hose. Additional, or alternatively, the lacing sensor may detect coupling of the first coupler of the first hose with the second coupler of the second hose. For example, the first coupler and the second coupler may be gladhands, and the lacing sensor may detect initial engagement of the gladhands (e.g., when the gladhands are positioned such that releasing the first hose and the second hose by the lacing actuator will cause the gladhands to rotate relative to one another, while maintaining engagement with one another, to cause coupling of the gladhands). The lacing sensor may detect that the gladhands are coupled (e.g., after releasing the first hose and the second hose by the lacing actuator). A suitable lacing sensor may be an optical sensor, a proximity sensor, an ultrasonic sensor, a magnetic sensor, a conductivity sensor, and/or another type of sensor selected with reference to the end use parameters. If the lacing sensor fails to detect receipt of a hose by the lacing actuator, the control circuit may initiate a repeat of the lacing step, may signal for aid to be dispatched, may initiate a remediation routine, may collect and send information about the situation, may perform a function check, or may respond in another manner selected with reference to the equipment and a determined operating plan.

The system may include a leak detection sensor. As noted above, when coupled, the first hose and the second hose may define a conduit for conveying a fluid between the first vehicle and the second vehicle. The leak detection sensor may detect a parameter indicative of a leak of fluid from the conduit. In one embodiment, the control circuit may signal for an air compressor to pressurized an air brake line, and the leak detection sensor may be a microphone listening for the sound of escaping air. The frame can move down a line of railcars listening for air leaks along the entirety of a train, for example. A suitable leak detection sensor may be, for example, a microphone, an optical sensor, a temperature sensor, a pressure sensor, a gas sensor, and/or another type of sensor selected with reference to end use parameters. If the leak detection sensor detects a leak, the control circuit may initiate a repeat of the lacing step, may signal for aid to be dispatched, may initiate a remediation routine, may collect and send information about the situation (such as the location or car number nearest the detected leak), may perform a function check, may signal to depressurize the line, or may respond in another manner selected with reference to the equipment and a determined operating plan.

In addition to the propulsion system of the frame, the control circuit may be communicatively coupled to one or more of the lacing actuator, the first grasper, the second grasper, the first guide, the second guide, the grasping sensor, the lacing sensor, and the leak detection sensor. The control circuit may receive inputs from the various sensors, actuators, and graspers and cause actuation of the lacing actuator, the first grasper, the second grasper based, the first guide, and/or the second guide at least in part, on the inputs. For example, the control circuit may actuate the first grasper and the second grasper to grasp the first hose and the second hose and deliver the first hose and the second hose to the lacing actuator based on inputs from the grasping sensor. The control circuit may actuate the lacing actuator based on inputs from the lacing sensor. The control circuit can repeat actuation of the lacing actuator, the first grasper, and the second grasper based on inputs from the leak detection sensor.

The control circuit may communicate wirelessly. For example, the control circuit may include a wireless communications module having an antenna for transmitting to and receiving signals from a remote controller. The remote control may receive inputs from an operator and transmit signals to the wireless communications module for remotely controlling operation of the system. The control circuit may have a processor and a memory with instructions for carrying out any of the processes described herein. For example, the control circuit can automatically control actuation of the lacing actuator, actuator of the first grasper, actuation of the second grasper, and movement of the frame based on inputs received from the various sensors, actuators, and graspers described herein.

In one embodiment, the first vehicle and the second vehicle may each be railcars movable along rails of a railway. In one example, the frame may move along the railway and below the railcars. In another example, the frame may move alongside the railway and alongside the railcars.

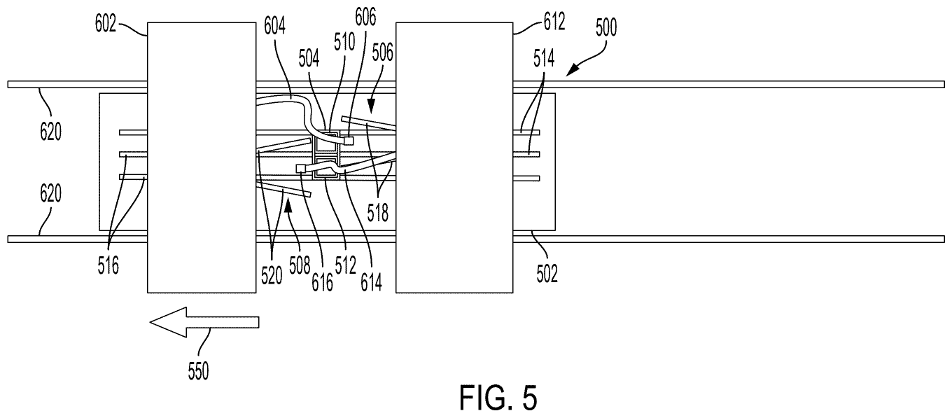

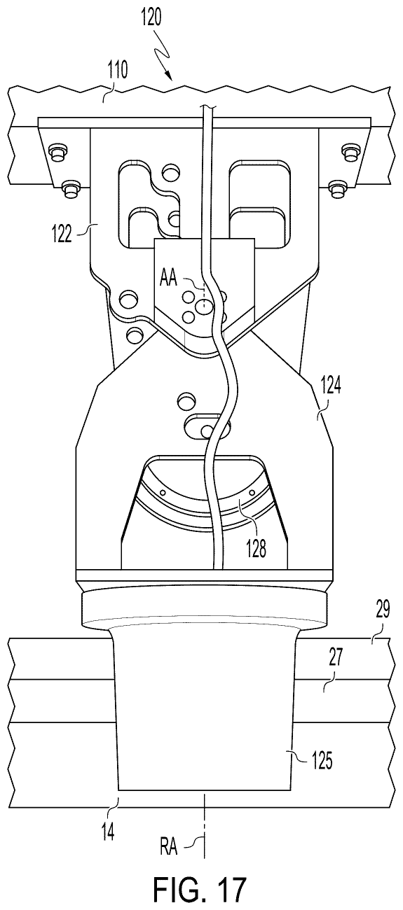

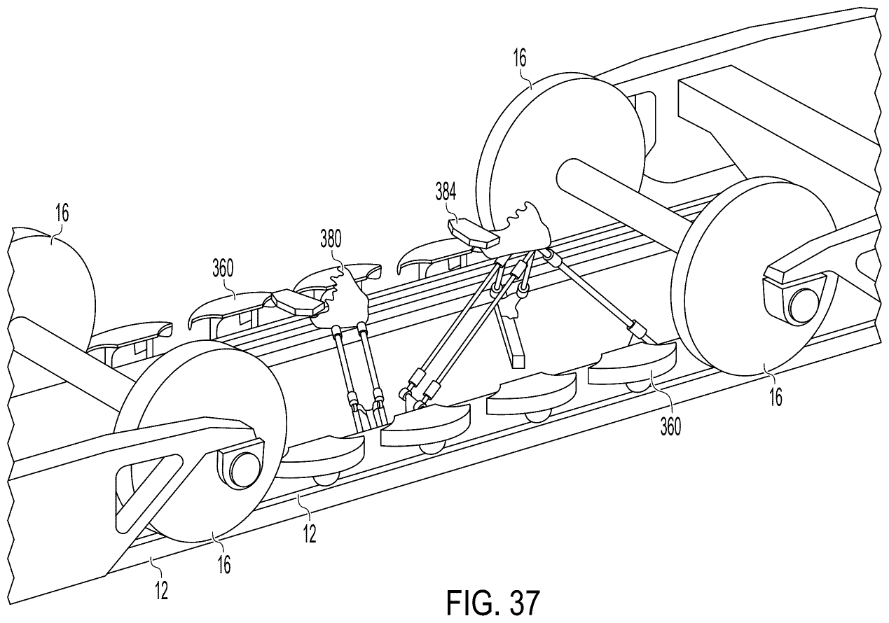

The system may incorporate features of the components of the systems for traveling along rails of a railway, as disclosed herein, such as components that retract, pivot, swivel, swing, or otherwise reposition to avoid contact with the rails cars while still allowing the system to progress along the railway. In some embodiments, the system for lacing hoses may include any of the systems and vehicles for traveling along rails of a railway disclosed with respect to FIGS. 8-37.

For example, the system may include a plurality of articulatable arms extending from the frame. Each articulatable arm may include a first joint portion attached to the frame, a second joint portion rotatably attached to the first joint portion about an articulation axis, a flanged wheel rotatably attached to the second joint portion such that the flanged wheel is rotatable relative to the second joint portion about a rotation axis, a drive motor that can rotate the flanged wheel about the rotation axis, and an actuator. Each actuator may rotate the corresponding second joint portion and the flanged wheel relative to the first joint portion about the articulation axis to transition the corresponding articulatable arm between a first configuration where the flanged wheel is engaged with and rests upon a resting surface of one of the rails and a second configuration where the flanged wheel is disengaged from the rails. Each articulatable arm, or pairs of arms, of the plurality of articulatable arms may be selectively actuatable between the first configuration and the second configuration.

In another embodiment, the disclosure provides a method for connecting hoses of a vehicle system using the hose lacing system described above. The vehicle system may comprise the first vehicle including the first hose and the second vehicle including the second hose, as described above.

In one embodiment, the method may include moving the first guide relative to the vehicle system in a first direction to lead the first hose of the first vehicle toward the first grasper. For example, the first guide may be fixed relative to the frame. The first guide may be moved relative to the vehicle system in the first direction by moving the frame relative to the vehicle system. As another example, the first guide may be actuated to lead the first hose toward the first grasper. The grasping sensor may sense that the first hose is proximate to the first grasper. The first grasper can grasp or otherwise capture the first hose (e.g., in jaws of the first grasper, in a catch defined by the grasper), for example, based on sensing that the first hose is proximate to the first grasper. The grasping sensor can sense that the first hose is captured by the first grasper. The first grasper can articulate to cause the first grasper to deliver the first hose to the lacing actuator, for example, based at least in part on sensing that the first hose is captured by the first grasper. Actuating the first grasper to cause the first grasper to deliver the first hose to the lacing actuator may include moving the first grasping along a first track.

The method may include moving the second guide relative to the vehicle system in a second direction different from the first direction to lead the second hose of the second vehicle toward the second grasper. For example, the second guide may be fixed relative to the frame. The second guide may be moved relative to the vehicle system in the second direction by moving the frame relative to the vehicle system. As another example, the first guide may be actuated to lead the first hose toward the first grasper.

The grasping sensor can sense that the second hose is proximate to the second grasper. The second grasper can articulate to grasp or otherwise capture the second hose (e.g., in jaws of the second grasper, in a catch defined by the second grasper), for example, based on sensing that the second hose is proximate to the second grasper. The grasping sensor can sense that the second hose is captured by the second grasper.

The second grasper may actuate to cause the second grasper to deliver the second hose to the lacing actuator, for example, based at least in part on sensing that the second hose is captured by the second grasper. Actuating the second grasper to cause the second grasper to deliver the second hose to the lacing actuator may include moving the second grasping along a second track.

The lacing actuator may actuate to position a first coupler of the first hose in engagement with the second coupler of the second hose. With the first coupler of the first hose in engagement with the second coupler of the second hose, the lacing actuator may be further actuated to couple the first coupler of the first hose and the second coupler of the second hose to define a conduit. In some embodiments, the conduit may be for conveying fluid between the first vehicle and the second. In some embodiments, the conduit may be for transmitting an electrical current and/or an electrical signal.

The vehicle system may include a third vehicle having a third hose. The second vehicle may additionally include a fourth hose. Once finished with the first lacing, the method may further include coupling the third hose of the third vehicle to the fourth hose of the second vehicle. The vehicle system may include additional vehicles with additional hoses. The method may include coupling additional hoses of additional vehicles, for example, similar to the coupling of the first hose and the second hose as disclosed herein.

Coupling the third hose of the third vehicle to the fourth hose of the second vehicle may include moving the first guide relative to the vehicle system in the first direction to lead the fourth hose of the second vehicle toward the first grasper and moving the second guide relative to the vehicle system in the second direction to lead the third hose of the third vehicle toward the second grasper. Similar to the above, the first grasper may be actuated to deliver the fourth hose to the lacing actuator and the second grasper may be actuated to deliver the third hose to the lacing actuator. The lacing actuator may be actuated to position a fourth coupling of the fourth hose in engagement with a third coupling of the third hose and couple the fourth hose with the third hose.

The vehicle system may further include additional vehicles (e.g., a fourth vehicle, a fifth vehicle, a sixth vehicle) each with additional hoses. The method may further include coupling the additional hoses, for example, similar to the coupling of the first hose and the second hose, and the coupling of the third hose and the fourth hose.

In some embodiments, a fluid may be conveyed between the first vehicle and the second vehicle through a first conduit defined by the first hose and the second hose. This may allow the fluid to flow through the entirety of the conduit defined by the hoses of plural vehicles. In particular, an air compressor may engage to pressurize the brake line with compressed air. Once pressurized, a sensor supported on the frame may detect for leaking fluid (air) if any of the hoses are not properly coupled or if there is a leak in the hose line.

Once coupled, an aspect of the method may sever the first conduit by disconnecting the first hose from the second hose. In one embodiment, the frame can traverse along the vehicles, locate and decouple each of the coupled gladhand connections.

In one example, the method may be performed automatically based on instructions stored by the control circuit. In anther example, the method may be performed based on signals received by the control circuit from a remote controller operated by a remote operator.

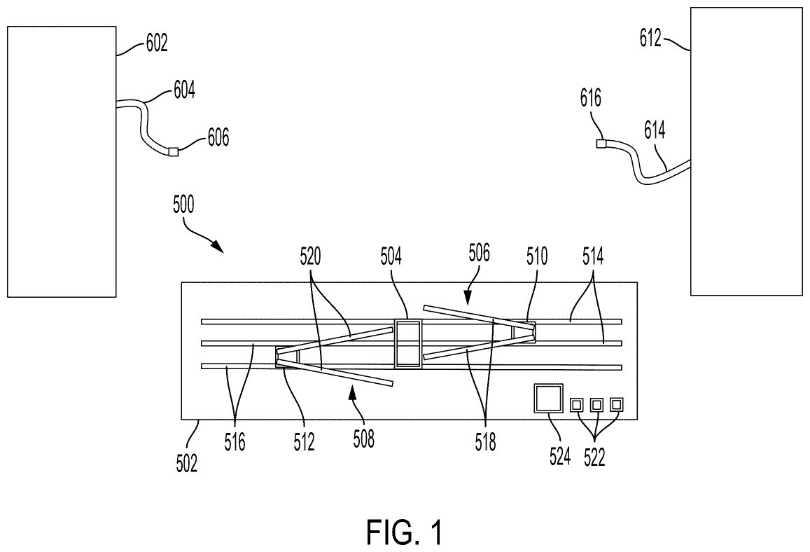

FIG. 1 illustrates a schematic of an example system 500 for connecting a first hose 604 of a first vehicle 602 and a second hose 614 of a second vehicle 612, in accordance with at least one aspect of the disclosure. In one example, the first vehicle and the second vehicle may be railcars of a train. In other examples, the first vehicle and the second vehicle may be another type of vehicle (e.g., trailers of a long combination vehicle). The first hose may include a first coupler 606 that is couplable to a second coupler 616 of the second hose.

The system may include a frame 502, a lacing actuator 504, a first guide 506, a second guide 508, a first grasper 510, and a second grasper 512. The first grasper is movable along a first movement area 514. The second grasper is movable along a second movement area 516. The first guide may include first arms 518 and the second guide may include second arms 520. The system may include a plurality of sensors 522. For example, the system may include the grasping sensor, the lacing sensor, or the leak detection sensor.

The system may include a control circuit 524. The control circuit may have a processor and a memory storing instructions to cause the processor to control various functions of the system, such as, for example, actuation of the lacing actuator, the first grasper, the second grasper, the first guide, and/or the second guide based on inputs from the plurality of sensors. The control circuit may include a wireless communications module including an antenna to transmit signals to and receive signals from a remote controller.

For example, the control circuit may transmit signals to the remote controller based on inputs from the plurality of sensors, the lacing actuator, the first grasper, the second grasper, the first guide, and//or the second guide. The remote controller may be coupled to an operator interface that displays indicators corresponding to the signals transmitted by the control circuit. A remote operator may view the displayed indicators and provide inputs to the operator interface for controlling the system. The remote controller can transmit signals corresponding to the inputs from the remoted operator to the control circuit. The control circuit can receive the signals from the remote controller and cause actuation of any of the lacing actuator, the first grasper, and the second grasper based on the signals.

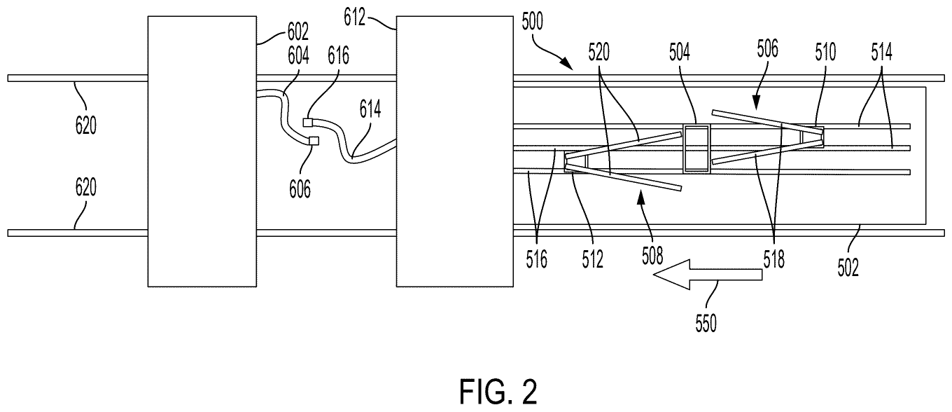

FIGS. 2-7 illustrate an example process for connecting a first hose of a first vehicle and a second hose of a second vehicle using the system of FIG. 1, in accordance with at least one aspect of the disclosure. In the example process illustrated by FIGS. 2-7, the system is depicted in plan view as traveling under the first vehicle and the second vehicle along rails 620 of a railway. In other examples, the system may travel alongside or above the first vehicle and the second vehicle.

Referring to FIG. 2, the first hose of the first vehicle and the second hose of the second vehicle are illustrated as freely hanging (e.g., dangling) from the first vehicle and the second vehicle. The system moves in a first direction 550 relative to the first vehicle and the second vehicle to initiate the process of directing the first hose toward the first grasper using the first guide.

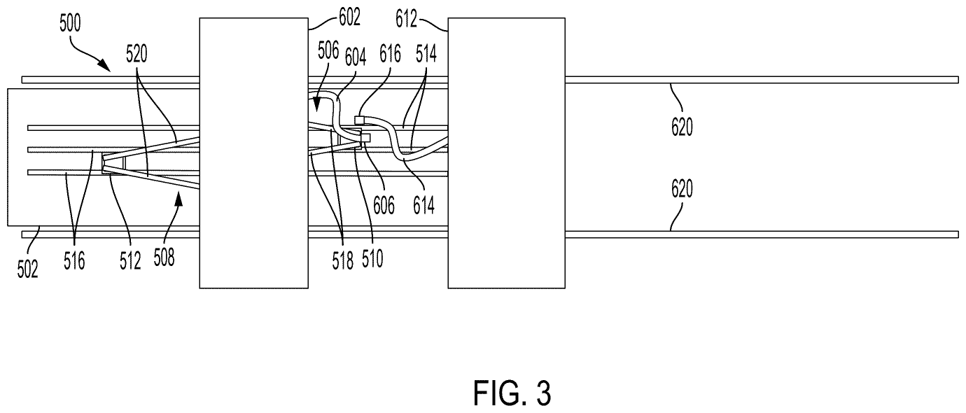

Referring now to FIG. 3, moving the system in the first direction has caused the first hose to be funneled by the first arms of the first guide to the first grasper. At this point, the grasping sensors may detect that the first hose is proximate to the first grasper. The control circuit may receive an input from the grasping sensor corresponding to the detection that the first hose is proximate to the first grasper. The control circuit may cause actuation of the first grasper, thereby causing the first grasper to grasp the first hose. The grasping sensors may detect that the first grasper has grasped the first hose. The control circuit may receive another input from the grasping sensor corresponding to the detection that the first grasper has grasped the first hose.

FIGS. 3A and 3B illustrate an example first grasper. As shown in FIG. 3A, the first grasper can include a u-shaped catch. An inner portion of the u-shaped catch can be sized to fit around the first hose. However, as shown in FIG. 3B, the inner portion of the u-shaped catch may be smaller than an outer profile of the first coupler, such that, as the hose slides through the first grasper, the u-shaped catch is impeded by the first coupler, thereby grasping the first hose.

Referring now to FIG. 4, the system moves in a second direction relative to the first vehicle and the second vehicle to initiate the process of directing the second hose toward the second grasper using the second guide. As illustrated by FIG. 4, moving the system in the second direction has caused the second hose to be funneled by the second arms of the second guide to the second grasper. As the vehicle moves in the second direction, the first grasper maintains a grasp of the first hose. Because the first hose is fixed to first vehicle, the first grasper may move along the first track to allow movement of the system relative to the first vehicle without causing excess tension on the first hose.

Still referring to FIG. 4, the grasping sensors may detect that the second hose is proximate to the second grasper. The control circuit may receive an input from the grasping sensor corresponding to the detection that the second hose is proximate to the first grasper. The control circuit may cause actuation of the second grasper, thereby causing the second grasper to grasp the second hose. The grasping sensors may detect that the second grasper has grasped the second hose. The control circuit may receive another input from the grasping sensor corresponding to the detection that the second grasper has grasped the second hose.

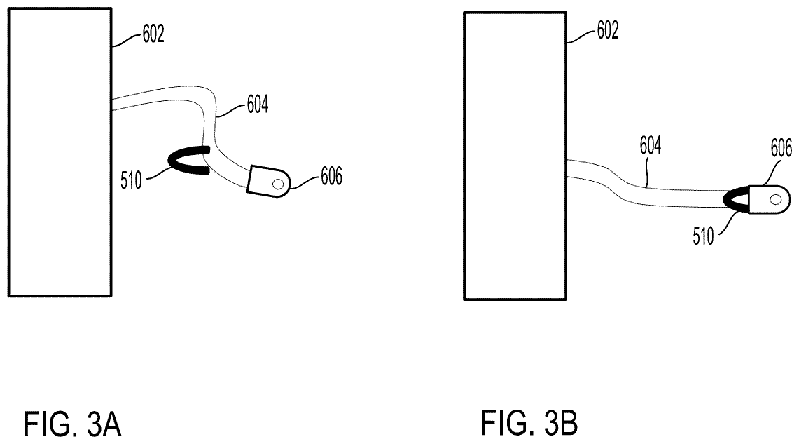

Referring now to FIG. 5, the first grasper travels along the first guide to deliver the first hose to the lacing actuator and the second grasper travels along the second guide to deliver the second hose to the lacing actuator. In one example, the first grasper may be allowed to freely move along the first track and the second grasper may be allowed to freely move along the second track such that movement of the system in the first direction causes the first grasper and the second grasper to deliver the first hose and the second hose to the lacing actuator. In another example, powered movement of the first grasper along the first track and the second grasper along the second track may cause the first grasper and the second grasper to deliver the first hose and the second hose to the lacing actuator.

Still referring to FIG. 5, the lacing sensor may detect that the first grasper has delivered the first hose to the lacing actuator or is otherwise positioned proximate to the lacing actuator. The lacing sensor may detect that the second grasper has delivered the second hose to the lacing actuator or is otherwise positioned proximate to the lacing actuator. The control circuit may receive input from the lacing actuator sensor based on the above referenced detections.

Referring now to FIG. 6, in some examples, the lacing sensor may detect that the first grasper has not delivered the first hose to the lacing actuator or is otherwise not positioned proximate to the lacing actuator. Additionally, or alternatively, the lacing sensor may detect that the second grasper has not delivered the second hose to the lacing actuator or is otherwise not positioned proximate to the lacing actuator. In one example, the system may be moved in the first direction, the second direction, or a combination of the first direction and the second direction until the lacing sensor detects that the first grasper and the second grasper have delivered the corresponding hoses to the lacing actuator. In another example, the first grasper and/or the second grasper may be repositioned via powered movement along the first track and/or the second track until the lacing sensor detects that the first grasper and the second grasper have delivered the corresponding hoses to the lacing actuator. The control circuit may receive input from the lacing actuator sensor based on the above referenced detections.

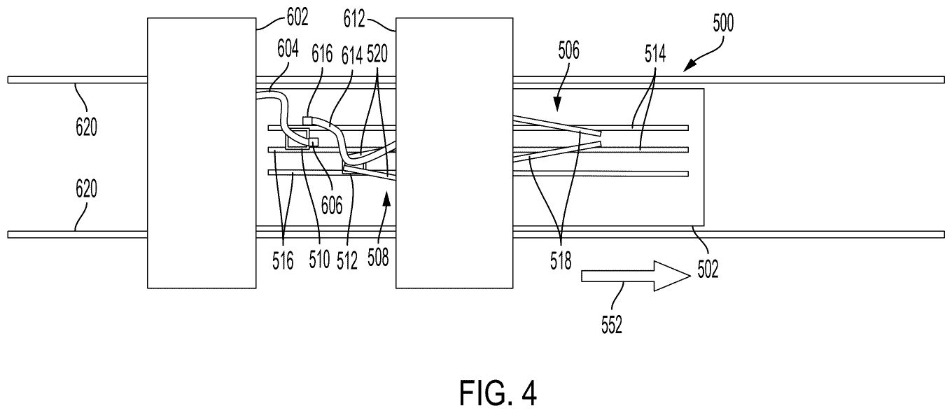

Returning to FIG. 5, based at least in part on detecting detect that the first grasper has delivered the first hose to the lacing actuator or is otherwise positioned proximate to the lacing actuator and the second grasper has delivered the second hose to the lacing actuator or is otherwise positioned proximate to the lacing actuator, the lacing actuator may be actuated to position the first coupling of the first hose in engagement with the second coupling of the second hose. The lacing sensor may detect engagement of the first hose and the second hose. The lacing actuator may be further actuated to couple the first coupling with the second coupling, thereby defining a conduit 622 (FIG. 7). In some embodiments, the conduit can convey a fluid between the first vehicle and the second vehicle. In some embodiments, the conduit can transmit an electrical signal and/or current. The lacing sensor may detect coupling of the first hose and the second hose.

FIG. 5A illustrates an example lacing actuator. The example lacing actuator includes a first coupler holder 550, a second coupler holder 552, a first hose manipulator 554, and a second hose manipulator 556. The first coupler holder can grasp and/or otherwise maneuver the first coupler of the first hose and the second coupler holder can grasp and/or maneuver the second coupler of the second hose to position the couplers for engagement. The first hose manipular can manipulate (e.g., kink, bend) the first hose and the second hose manipulator can manipulate (e.g., kink, bend) the second hose, for example, to position the ends of the hoses at an approximately 90-degree angle relative to one another (e.g., similar to FIG. 7B). The first hose manipular can manipulate the first hose, and the second hose manipulator can manipulate the second hose, for example, to cause relative rotation of the hoses after engagement of the first coupler and the second coupler to cause coupling of the first hose and the second hose (e.g., similar to FIG. 7C). In some examples, the first hose manipulator and the second hose manipulator may be coupled to or otherwise include the first grasper and the second grasper, respectively.

Referring now to FIG. 7, in some examples, the system may move in the first direction or the second direction to repeat the above-described process with respect to another set of hoses (e.g., a third hose a third vehicle system and a fourth hose of the first vehicle system). In some examples, such as when several or all hose pairs of a vehicle system have been attempted to be coupled by the system, the system may move in the first direction or the second direction such that the leak detection sensor travels by the first hose and the second hose (e.g., and other hose pairs of the vehicle system). The leak detection sensor may detect that the conduit defined by the first hose and the second hose is leaking or that the first hose and the second hose are otherwise not properly coupled. If the leak detection sensor detects a leak or that that the first hose and the second hose are otherwise not properly coupled, the system may repeat the process of coupling the first hose and the second hose, as described above. In one example, the system may sever any connection or partial connection of the first coupling and the second coupling before repeating the process of coupling the first hose and the second hose.

In some examples, at least some of the components of the system may not be coupled to the frame. For example, the first guide, the second guide, the first grasper, and/or the second grasper may be positioned on a wayside station that the first vehicle and the second vehicle travel proximate to. The first guide, the second guide, the first grasper, and/or the second grasper may collect and/or reposition the first hose and/or the second hose as the first vehicle and the second vehicle travel past the wayside station, for example, to facilitate lacing by the lacing actuator. The system including the lacing actuator may then travel to the collected and/or repositioned hoses to coupled the hoses.

FIGS. 7A-7C illustrates an example process for coupling a first gladhand 706 of a first hose 704 to a second gladhand 716 of a second hose 714 by a lacing actuator. Initially, the first hose 704 and the second hose 714 are separate, as shown in FIG. 7A. To couple the first gladhand the second gladhand, the lacing actuator angles a first end portion 708 of the first hose and a second end portion 718 of the second hose the second hose at approximately 90 degrees and engages the first gladhand is engaged with the second gladhand, as shown in FIG. 7B. With the first gladhand is engaged with the second gladhand, the lacing actuator aligns the end portion of the first hose with the end portion of the second hose (e.g., by releasing the hoses and allowing the hoses to hang freely), causing relative rotation of the first gladhand and the second gladhand, thereby coupling of the first gladhand and the second gladhand, as shown in FIG. 7C.

Various subject matter described herein relates to a vehicle and a method for moving the vehicle along a route. Any aspect of the vehicle and method for moving the vehicle along a route described further below may combined with the system and method for coupling hoses described above. For example, the system for coupling hoses described above may employ components of the vehicle described below for moving the system along rail of a railway. The frame of the system described above may correspond to the frame described below.

During operation, a vehicle may interact with other transport vehicles, such as a railcar, on the route by moving past them while re-positioning its support structures. In one embodiment, the vehicle may approach a transport vehicle and retract, pivot, swivel, swing, or otherwise reposition its wheels or support structures to avoid contact while still allowing the vehicle to progress along the route or track. In one embodiment, as the vehicles traverse relative to each other, no portion of the system touches or engages any portion of the train/car/wagon. In particular, the wheels of the two vehicles do not collide when moving past or across each other.

In one embodiment, the vehicle is a system that has a frame with a longitudinal axis and, on each of two opposite sides of the longitudinal axis, a plurality of support structures. The support structures each include a support element that can engage an upper surface of a route. In the illustrated embodiment, the route is a pair of rails that form a rail track. The support element may include a connection element connecting the support element to the frame, the connection element may allow the support element to move from a first position to a second position. The movement may be characterized relative to the frame. In various embodiments, the first position may be an operative position, an extended position, a supported position, an on-rail position, and/or an engaged position; and, the second position may be an inoperative position, a retracted position, a pivot position, a swung position, a swivel position, an unsupported position, an off-rail position, and/or a disengaged position.

The connection element may include or be coupled with an actuating element. The actuating element may actuate the support element from the first position to the second position and/or from the second position to the first position. At least part of each support element of each support structure on one of the sides of the longitudinal axis extending, when in the first position and when the system is projected onto a horizontal plane, farther than a determined distance from the longitudinal axis, at least part of each support element of each support structure on the other of the sides of the longitudinal axis, the other side being opposite to the first side, extending, when in the first position and when the system is projected onto the horizontal plane, farther than the determined distance from the longitudinal axis, no part of the support elements extends, when in the second position and when the system is projected onto the horizontal plane, farther than the determined distance from the longitudinal axis. That is, the support structures may pivot forwards and/or backwards to avoid collision or interference with the wheels of the rail vehicles. In other embodiments, the support structures may retract towards the center between the tracks or may pivot upwards out of the horizontal plane.

The frame may have a longitudinal axis which normally would be a center axis of the frame. The longitudinal axis normally would be parallel to the rails or track and may be a center line between the rails.

A railway track may have two rails that are at least substantially parallel and have the same distance between them, seen in a direction perpendicular to the direction of either rail. Each rail having a top portion, a foot portion, and a web intermediate the top portion and the foot portion. In various embodiments, the top portion of the rail may be a running surface, or a resting surface, for a wheel of a train or railcar. A plurality of support structures is provided on either side of the longitudinal axis and thus engage each of the two rails along a plurality of positions thereof. This has the advantage that as a train wheel is passing, or as the system moves past a train wheel, the train wheel may require one or more of the support structures to not engage the rail, while others remain in engagement, so that the frame is supported by the rails even when train wheels pass. In one embodiment, the support structures engage the top portion, or resting surface, of the rail of the railway. In an alternative embodiment, the support structures engage the foot portion of the rail of the railway.

The support elements engaging one rail engage this rail at a plurality of known positions along the rail. These positions may be equidistant and determined based on the dimensions of train/wagon/car wheels and/or the distance between these on the train/car/wagon, such as on a bogie thereof.

Each support structure may include a support element that can engage an upper surface of a railway rail. This upper surface is the same surface by which the train wheels are supported when the train sits on or moves along the track.

In order for the frame to be supported by the support elements, a connection element is provided for each support structure for connecting the support element to the frame. Because the train wheels are also supported by the upper surface of the railway rail, the connection element allows the support element to move, relative to the frame, from a first position to a second position to retract, pivot, swivel, swing, or otherwise reposition the support structures to avoid contact with the train wheels while still allowing the vehicle to progress along the route or track or allowing the vehicle to remain stationary as the train wheels pass by.

In the first position, at least part of the support element extends, when projected onto a horizontal plane, farther than a determined distance from the longitudinal axis. The determined distance may be a distance from the longitudinal axis and to an inner edge of the upper surface of the rail, an inner surface of the head of the rail or an inner surface of the train/wagon/car wheel or the radially outermost portions thereof. When in the first position, the support element extends to above the upper surface of the rail so that it may engage it such as being supported thereon.

In the second position, no part of the support element extends, when projected onto the horizontal plane, farther than the determined distance from the longitudinal axis. Thus, the train/car/wagon wheel may pass this position of the system without engaging the support element. Or, if the system is in motion, this position of the system may pass the train/car/wagon wheel without the support element engaging the wheel. As described further below, the second position may be a position where the support element is positioned so that it does not engage a train wheel when passing on the pertaining rail. The second position may be positioned vertically as well as horizontally away from the first position.

The connection element may include an actuating element for actuating the support element from the first position to the second position and/or from the second position to the first position. The actuating element may include any type of actuator, such as a hydraulic actuator, gas pressure actuator, electrical or combustion motor/engine, or a passive actuator, such as a spring or other resilient element biasing the support element toward one of the first or second position. An actuator element may be one that can engage with the rail or a wheel of a train/wagon/car to derive force or torque therefrom for providing the actuating operation.

At least part of each support element of each support structure on one of the sides of the longitudinal axis extend, when in the first position and when the system is projected onto a horizontal plane, farther than a determined distance from the longitudinal axis. In this manner, all support elements, when in the first position, may be supported on the pertaining rail. As long as one or more support elements are supported on the rail, others may be in the second position.

The same is the situation for the support elements engaging the other rail of the track. At least part of each support element of each support structure on the other of the sides of the longitudinal axis, the other side being opposite to the first side, extending, when in the first position and when the system is projected onto the horizontal plane, farther than the determined distance from the longitudinal axis.

In one embodiment, no part of the support elements may extend, when in the second position and when the system is projected onto the horizontal plane, farther than the determined distance from the longitudinal axis. It may be desirable to keep the part of the frame from extending farther away from the axis than the determined distance. Thus, the frame, when projected onto the plane, may be disposed entirely between the rails. In this manner, no part of the frame may be engaged by any train/wagon/car wheels passing or passed by the frame on the rails.

If the longitudinal axis is not defined at the center between the rails, the above determined distance may not be the same on the two sides of the axis. Then, two determined distances would be used, but this does not alter the function of the support elements nor the first and second positions.

During one portion of the operation, at least one set or more of the support elements may be supporting the frame between the rails and not touching the ground, the ties, or sleepers between the rails. In another operational mode, such as the traversal of a crossing where the road is higher than the sleepers or ties, the vehicle may bottom out such that additional sets of wheels or skids support the vehicle weight through the crossing. The propulsion may be provided in one of several ways, such as a drive element for wheels on the underbelly of the vehicle, or by moving the support elements to a third position, such as tilted downward towards the rails to obtain traction or tilted upward away from the rails to raise the frame of the vehicle above an obstruction. In one embodiment, the connection element may be attached to the frame such that it is pivotable relative to the frame about an axis that is parallel to the ground. In such instances, the actuation of the connection element can raise and/or lower the frame relative to the rails. In one embodiment, a linear actuator may be positioned between the connection element and the frame to raise and/or lower the connection element and the support element relative to the frame.

In one embodiment, the system may include a drive for moving the system along the rails. In this situation, the system may move along the rails and perform a desired function. Suitable payloads and functions may include storage for moving goods below the train, an inspection package containing one or more sensors (e.g., to sense the undercarriage of a rail vehicle, or the condition of the track/tie/ballast/switch), robotic arms for performing tasks (such as, e.g., lacing brake hoses), power provisioning to charge other devices, tools to clean or clear aspects of tracks or switches (e.g., clearing rocks from a stuck switch), cleaners for removing debris or contamination (e.g., from the track surface), abrasives or grit to facilitate tractive effort for another vehicle, safety equipment (e.g., fire suppression materials), communication relay or extender equipment, warning notices, GPS and location devices, positive vehicle control devices, and the like. Further, the system may provide visual point inspection of the rails of the railway and/or vehicles positioned on, or adjacent to, the railway. The system may provide railway track mapping and/or location auditing. Further, the system may provide rolling stock inventory counting and/or location verification of rolling stock. In one embodiment, the system may inspect and/or gather data on tracks (including ties, spikes, anchors), ballast, foliage, and wayside terrain. With regard to the terrain, the data collection can include moisture content (including water level), soil compaction level, grade (overall and the rail level relative to each other), the presence or absence of fallen rocks, degree of washout, and the like. Another item to monitor may include leaf and bug coverage of the rail surface, and another may include the state of infrastructure for transportation (or otherwise), with an example being aspects of a bridge by which the rail tracks are supported.

In one embodiment, the support elements are support rollers or tracks, and there is a drive element connected to at least two of the support rollers/tracks so as to rotate or otherwise power these. The drive element may engage the wheels, which in turn engage the rails and move the system along the rails. The system may include a power source. Suitable power sources may include one or more of a combustion engine, a fuel cell, a solar cell, a battery, and the like. A suitable control circuit may actuate the drive, which may be done via remote control, via a tether, or by autonomous function.

In one embodiment, at least one connection element may include a first portion fixed in relation to the frame, and a second portion including the support element. The second portion may be movable in relation to the first portion to bring the support element from the first position to the second position. The actuating element may be used to switch positional modes of the portions. The first portion may be coupled to and part of the frame. This first portion may be positioned no farther from the axis than the determined distance so that the first portion is positioned, in the projection onto the plane, between the rails.

When the support element is a support roller or track, this roller/track may be rotatably provided in relation to a remainder of the second portion. The actuating element may be embodied in a number of manners. The actuating element may be completely or partly mechanical and may require no external power source. Alternatively, the actuating element may require power to actuate the support element in one direction between the first and second positions or in both directions.

The movement from the first to the second position may be selected with reference to the design of the frame. The support element may translate horizontally toward the axis to move to the second position. Alternatively, or additionally, the support element may be rotated around an axis, such as an axis which is closer to the frame than the determined distance. The rotation may be around a rotational axis, such as a horizontal axis or a vertical axis. It may be desired that the support element, and sometimes all of the system, does not interfere with a passing wheel or with any portion of a passing train/wagon/car. When the support element is in the second position, it is desired that no part of the pertaining support structure is positioned farther from the axis than the determined distance.

Situations may exist where the support element is attached to a pushing element, which may engage the passing wheel and acts to position the support element in the second position. In other situations, the movement of the support element takes place using other components where it may then be desired that no part of the system touches any part of the train/car/wagon.

In one embodiment, the actuating element may include a pushing element fixed in relation to the second portion, wherein, when projected onto the plane: at least part of the actuating element extends farther than the determined distance from the longitudinal axis, when the pertaining support element is in the first position, and no part of the actuating element extends farther than the determined distance from the longitudinal axis, when the support element is in the second position.

This pushing element may be that can engage an approaching wheel of a train/car/wagon and use a relative velocity between the frame (or first portion of the pertaining support structure) and the wheel to displace in relation to the first portion and thereby cause actuation of the pertaining support element from the first position to the second position. Then, the passing wheel may cause both the support element and the pushing element to move out of the path of the wheel. When the wheel has passed, the pushing element may disengage the wheel and allow itself and the support element to return to the first position.

In one situation, the pushing element is positioned higher than the support element. The pushing element is positioned to engage the wheel at a height (along a vertical axis) closer to that of the rotational axis of the wheel, as that position of the wheel will be further along the direction of movement thereof than portions farther from the axis of rotation. The pusher element may engage the wheel before the wheel reaches the support element.

The pushing element may extend farther, in the projection and at the determined distance, along the longitudinal axis than any portion of the support element. In this manner, when the pushing element engages the wheel, the wheel will not engage the support element.

In one embodiment, the system may include a sensor for sensing an obstruction, such as a wheel, in the determined distance from the longitudinal axis and in the vicinity of a determined support element, the pertaining actuating element being that can, based on an output of the sensor, actuate the determined support element from the first position to the second position.

The sensor may sense obstructions, such as wheels, at a longer distance from the axis. Also, the sensor may be positioned to detect the obstruction before the obstruction reaches the pertaining support element to give the actuating element time to, if not automatic, react and bring that support element to the second position. If the wheel is always expected to travel in one direction on the rail, the sensor may be positioned to detect the wheel a position before the wheel arrives at the position at which the pertaining support element engages the rail.

The same sensor may be used for controlling the operation of multiple actuating elements. On the one hand, the wheels of trains, cars and wagons aways are provided in pairs so that the position of one wheel on one rail will dictate the position of a wheel on the other rail. On the other hand, the velocity of the wheel vis-à-vis the system may be determined so that the timing of the operation of the individual actuating elements may be determined.

In one embodiment, the system may include a control circuit. The control circuit may, based at least in part on a received signal, control the actuating elements of connection elements to actuate the support elements to (or from) the second position. Actuating all support elements to the second position would not likely allow the system to support itself on the rails. The system may then enter this mode and sit, in the projection onto the plane, between the rails to not be in the way of train wheels moving along the rails.

This mode may be entered when the system has completed a task or when a malfunction is detected. Also, if a fast-moving train is approaching, the system may enter this mode if it is not able to operate the actuating elements sufficiently fast enough for the wheels to be able to pass while at least some of the support elements are in the first position. Clearly, other reasons may exist for entering this mode and thus avoiding interaction with the train wheels.

Another aspect of the disclosure relates to a method of operating the system disclosed above. The method may include providing the system on the first and second rails of a railway track with the support elements in the first position and engaging the first and second rails, the system passing a pair of wheels of a railway car standing on or moving along the first and second rails, by, for each support element: when the support element approaches a wheel, the pertaining actuating element actuates the pertaining support element to the second position and/or when the support element has passed the wheel, the pertaining actuating element actuates the pertaining support element to the first position.

The wheels(s) of the train/car/wagon may travel along the rails, where the system, such as the frame, may remain stationary in relation to the rails or it may itself move along the rails. A train/car/wagon often has multiple axles and wheels. These may be positioned in pairs of wheels positioned at the same position along the rails (an axle, a line or axis between the two wheels is perpendicular to the direction of the rails). Thus, the support elements on either side of the frame may be operated similarly and simultaneously.

The first and second positions are as described above. A support element may initially be in the second state so that it needs not initially move away from an approaching wheel but will want to engage the rail after the wheel has passed. Also, a support element may not need to re-engage the rail after passing of the wheel. Situations exist where it may be desired to have only a minimum number of support elements engage the rails while maintaining a sufficient or desired position and support of the frame.

The method may include both the actuating of the support element to the second position and to the first state. The wheel may approach a support element when a relative velocity is seen between the two. Either element - or both - may move in relation to the rails. When the wheel approaches a support element (or vice versa), the pertaining actuating element actuates the pertaining support element to the second position to allow the wheel to pass the position at which the support element engaged the upper surface of the rail. The second position is selected so that the support element, and in some situations any part of the support structure or system, does not interfere with, such as touch, the passing wheel.

In some situations, no part of the system touches any part of the wheel or the train/car/wagon when the wheel and system pass each other. In other situations, the system may include an element, such as a pusher element, engaging the passing wheel in order to actuate the support element to the second position.

In response to the support element having passed the wheel, or vice versa, the control circuit may cause the pertaining actuating element actuates the pertaining support element to the first position to again support the support element on the rail, often at the same position (in relation to the frame). In one embodiment, the system moves along the rails. The train/wagon/car may be stationary in relation to the rails, or they may move along the rails. Alternatively, the system may be stationary in relation to the rails where the train/wagon/car move along the rails.

In one embodiment, the support elements are support rollers or tracks, the system may have a drive unit connected to at least two of the support rollers. During use, the drive unit may provide motive power or may rotate the coupled support rollers/tracks. In this manner, the system may be able to move along the rails. A plurality of support rollers/tracks are driven, as this may allow some to be in the second position while others are in the first position.

In one embodiment, the actuating element of at least one connection element actuates the support element to the second position by moving a second portion, including the support element, in relation to a first portion fixed in relation to the frame. As mentioned above, the first portion may form part of the frame. The second portion may allow the support element to rotate in relation to the first portion or a part of the second portion.

In one embodiment, a pushing element of the actuating element of at the least one connection element engages one of the wheels, is pushed by a relative velocity between the wheel and the pushing element and actuates the pertaining support element from the first position to the second position. Thus, no extra power source is required, as the torque or force required may be derived from the relative movement between the wheel and the pushing element.

In one embodiment, a sensor outputs a signal when a support element and the wheel are a determined distance relative to each other, the pertaining actuating element receiving the signal and actuate the determined support element from the first position to the second position. A suitable sensor may be a camera, optical sensor, magnetic sensor, galvanic sensor, hall sensor, or the like. The sensor may sense a distance to a wheel or obstacle, a position of a wheel, a velocity of the wheel, a direction of movement of the wheel, and the like. The control circuit may actuate the actuating element to switch positional modes of the support element. The control circuit may receive a signal and control the actuating elements of one or more connection elements to actuate all support elements to the second position. This mode may be activated if a malfunction of the system is detected or a fast-moving train is expected. Another suitable mode for the control circuit to select is a safe-mode in which movement or actuation may injure or cause harm. In one embodiment, the control circuit may not initiate movement or actuation without assurance that a determined area is clear.

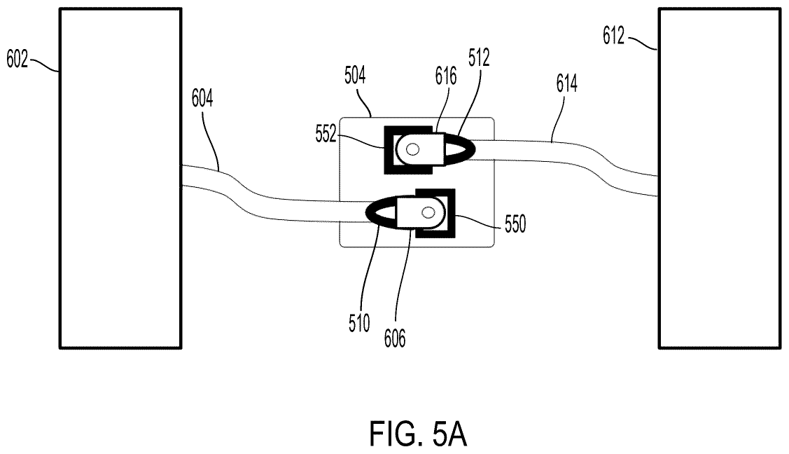

FIG. 8 illustrates a system 10 that can travel along first and second rails 12, 14, of a railway track, on which trains and cars may travel, each on multiple sets of wheels 16, which are supported on the rails. The system may include a frame 20 and support structures 22 distributed to have five support structures on one side of a longitudinal axis L, and another five support structures on the other side thereof. As is seen in FIG. 9, each support structure has a support roller 24 that can engage a top portion 27, or running surface, of the pertaining rail, so as to support the system when driving along the track. In an alternative embodiment, the support rollers engage a foot portion 29 on the inside of the track so as to support the system when driving along the track.

Railway wheels are supported on the top of the rails, so that the support rollers cannot easily move along the rails below a railway car. Also, the railway wheels have an inner protrusion 162, extending downwardly, relative to the running surface, from the wheel and on the inner side of the rail. This is for ensuring that the train/car/wagon/truck stays on the track, but this protrusion requires the support roller to be removed from engagement with the rail when passing a wheel.

The support structure may include two portions which are movable in relation to each other. A first portion 28 is attached to the frame and another, second portion 26, is rotatably connected to the support roller. In this embodiment, the second portion is translatable, perpendicular to the longitudinal axis, L, in relation to the first portion and the frame, so that the support roller is moved inwardly of the rail to allow the wheel to pass without damaging the support roller. The support roller may be moved sufficiently far inwardly to not engage with the wheel. This position is called the “second” position of this roller, where the position illustrated, where the roller rests on the rail, is called the “first position”.

A drive unit 18 may provide motive effort to some of or all of the support rollers to drive the system along the rails. When a sufficient number of support structures are provided on either side of the axis, L, the system is able to move between multiple pairs of wheels while a sufficient number of support rollers engage the rail so that the system may both remain supported by the rails and be able to move along them while different ones of the support structures bring the individual support rollers from the first position to the second position and back to the first position.

The first and second positions may be defined by the distance from the support roller to the axis L, such as when the elements are projected onto a horizonal plane, or a plane defined by the rails. When in the first position, the support rollers are, in the projection, at or on the rails, whereas in the second state, they are closer to the axis L. The threshold distance thus may be any distance between the axis L, often between relevant portions of the frame, and the innermost portions of the rails or the railcar wheels on the rails (taking into account the projection).

In FIGS. 8 and 9, a larger wheel, a pusher wheel 32, is illustrated, which lies above the support roller and extends farther along the directions of the axis L. The pusher wheel extends at least as far away from the axis L as the support roller. The pusher wheel, in this embodiment, has the operation of moving the support roller from the first to the second position when a wheel 16 approaches. The pusher wheel engages the approaching wheel and is forced toward the axis L by the approaching wheel and the fact that the wheel is mounted on the second portion which is translatable in relation to the portion and the frame. This translation brings the pertaining support roller away from the rail so that the wheel may pass. When the wheel has passed, the pusher wheel disengages the wheel and thus allows the second portion to extend so that the support roller may again support on the upper side of the rail. A spring or other resilient means may be provided for biasing the second portion toward having the support roller in the operational position.

The pusher wheel may not be connected directly to the second portion but may be in a geared relationship so that a relatively small displacement of the roller wheel toward the axis L may bring about a larger displacement in the same direction of the support roller.

Small rollers 324 may engage the inner surface of the rail. These are alternatives to the projections of the wheels and have the purpose of ensuring that the rollers do not pass to the inner or outer sides of the rails. Alternatively, projections may be provided as on the wheel. The second portions may be biased toward the rail to take into account situations where the distance between the rails varies slightly.

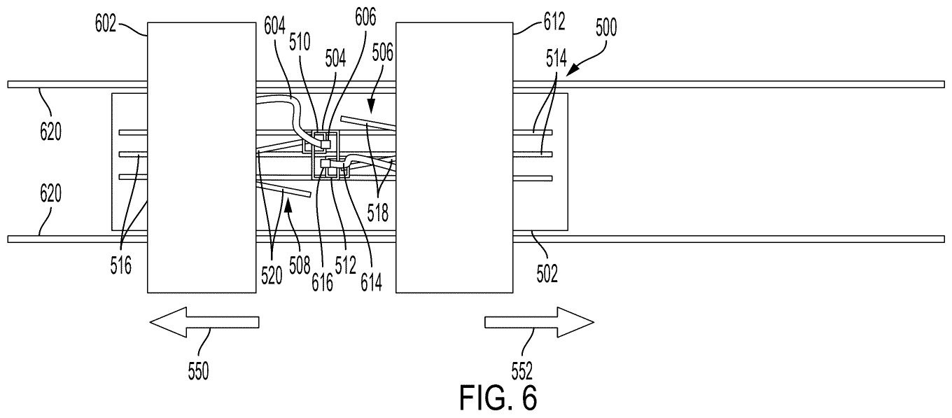

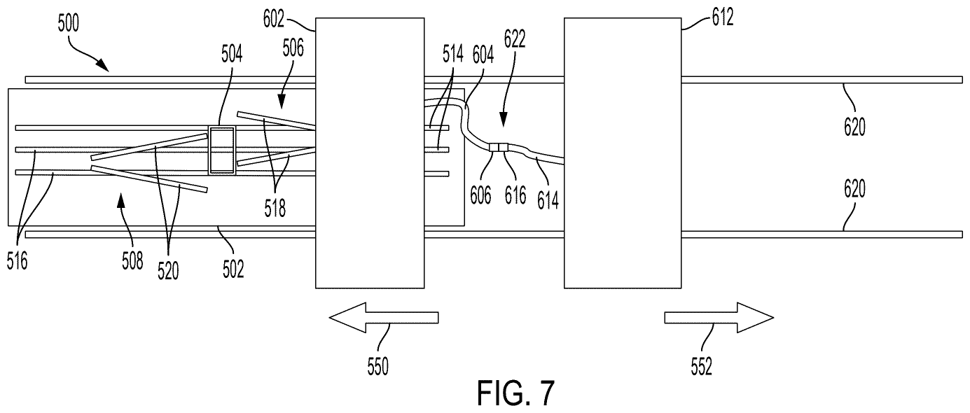

Multiple other manners exist of moving the supporting roller between the first and second position. Some of these manners are described in relation to FIGS. 10-11.

In FIG. 10, another manner of bringing the support roller from the first to the second position is illustrated in the system seen from above. Again, the frame is attached to the support structure having a first portion fixed to the frame and second portion movably, this time rotatably, attached to the first portion and to which the support roller is rotatably attached.

In this embodiment, the second portion is rotatable around a vertical axis as illustrated. The second portion may have a pusher element 322 positioned on the side of the support roller from which the rail vehicle wheel approaches. In FIG. 10, the rail vehicle wheel moves upwardly along the rail.

It is seen that the pusher element will engage the wheel before it reaches the support roller and will push the portion along the direction of travelling, causing the second portion to rotate, as the support structure supports this rotation.

The pusher element will remain between the support roller and the wheel until the wheel is out of engagement, whereafter the portion will rotate back to the first position.

In FIG. 11, a rotation around a horizontal axis brings the support roller from the first position (illustrated to the right) to the second position illustrated to the left.

Above, the manner of bringing the support roller into the second position has been described using direct engagement of a portion of the system and the approaching train car wheel. Naturally, other manners are useful also, such as a sensor 262 that can sense or detect the arriving wheel, such as a position thereof. This sensor may output a signal to the control circuit, which may operate an actuating element 282 that can bring the pertaining support roller into the second position and/or between the first and second positions. This sensor may be image based, sound based or may be of any other type.

One sensor is not required for each support structure, if the velocity of the wheel is known, relative to the system, such as if the train car including the wheel is stationary vis-à-vis the rails where the system may know its own speed vis-à-vis the rails, such as by controlling its drive. In such situations, the position of the wheel vis-à-vis each individual support structure on the same rail may be known over time, so that the wheel may be detected when approaching the system proper and then, individual support structures may be operated at determined points in time to allow the wheel to pass. This pass event may be accomplished without damage to the system.

In one embodiment, the support roller may have a square cross section in a plane including the axis of rotation. In another embodiment the support roller may have a conical cross section in that plane. This may be relevant e.g. when the translation of FIG. 8 is seen, as the frame and/or portions may not be perfectly stiff, so that the support roller when approaching the rail when being brought back to the first state, may be slightly offset downwardly, where the conical shape may assist in ensuring that the roller again engages the upper side of the rail.

Another reason for having conical rollers is that they, when paired with a solid axle or a mechanism that makes left and right rollers turn the same amount, keep the frame centered between the rails. With cylindrical rollers, it can be advantageous to actively steer to stay on the rails. With coupled conical rollers, when the system starts to deviate to one side, then the roller on that side engages the rail with a larger diameter than the roller on the other side. Because the two rollers are coupled, the larger diameter makes the roller on the side toward which the system has deviated move farther than the roller on the other side, steering the system back to center.

In one embodiment, the control circuit may control the support structures to bring the corresponding support rollers to the second state. When all support rollers go to the second state, the system will no longer be supported by the rails but may fall to the ground between the rails. This may be a safety feature allowing the system to remain intact in situations where trains and cars travel on the rails. If, for example, a train is approaching at a speed so fast that the support structures are not able to react sufficiently, this mode may be assumed so that the system is not destroyed by the train.

In the above embodiments, the system has been described using support rollers. Naturally, alternative types of elements may be used, such as tracks. Also, above, a drive is described rotating at least some of the support rollers to move the system along the rails. Clearly, other types of drives may be used, such as drives engaging the wheels, rail vehicles/wagons, the ground or the rails in other manners, so that the support rollers/tracks need not be driven. Actually, the above support rollers may be replaced by other support elements than rollers, such as non-rotating elements, which may slide along the rails. Sliding may not even be required, as the system may be that can sit in a stationary manner on the tracks where the train/car/wagon/wheels move along the track.

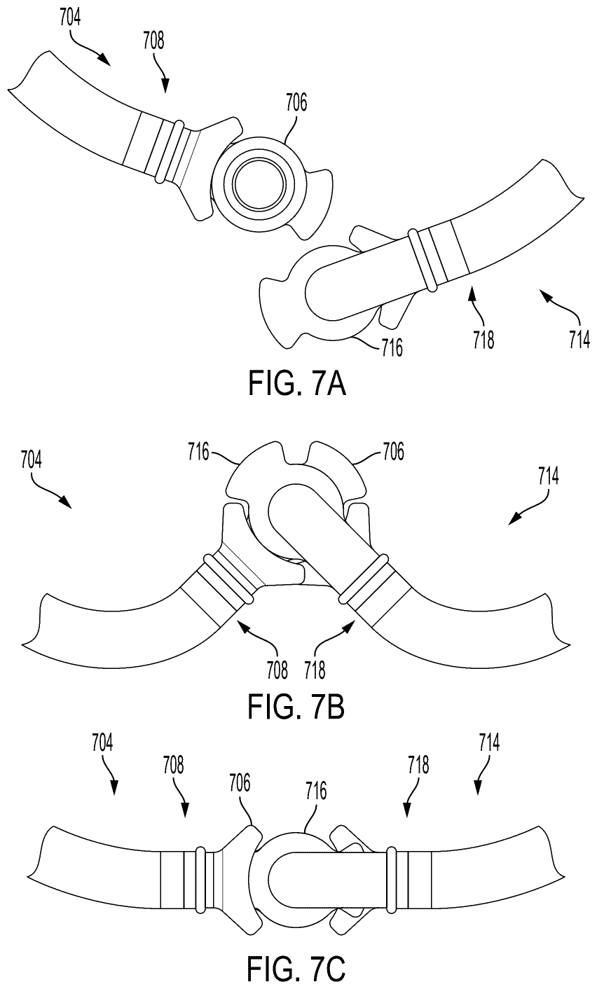

FIG. 12 illustrates a vehicle 100 for traveling along a railway rail. The vehicle is capable of traversing underneath of a rail vehicle and/or permitting a rail vehicle to traverse overtop it. The vehicle may include a frame 110 and a plurality of connection elements, or articulatable arms 120 extending from the frame. The frame defines a lateral frame width LFW that is less than the distance between a pair of rails of a railway, for example. A suitable frame may be rectangular in shape. The frame has cross bracing 112 to provide rigidity to the frame. In various aspects, the cross bracing provides mounting locations for various railway maintenance components, as discussed in greater detail elsewhere herein.

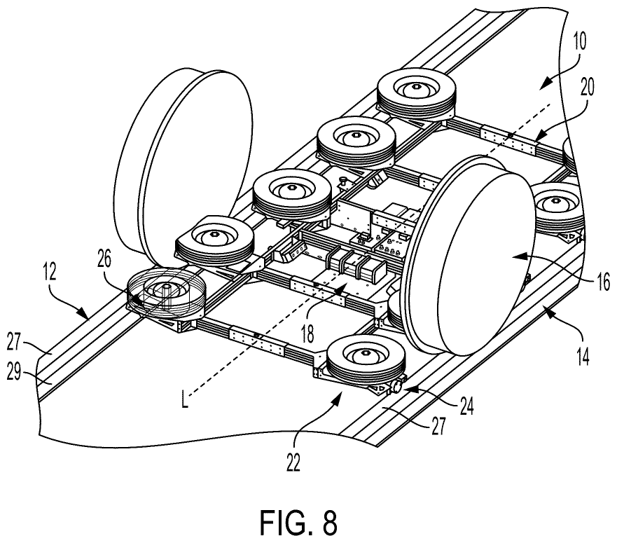

The vehicle may include eight articulatable arms with four articulatable arms positioned on either side of a longitudinal axis LA defined by the frame. In another embodiment, as illustrated in FIG. 13, a vehicle 200 may include twelve articulatable arms in six sets with pairs of articulatable arms positioned on either side of the longitudinal axis LA of the frame. In another embodiment, a vehicle can include at least six articulatable arms with three articulatable arms positioned on either side of the longitudinal axis LA of the frame. In another embodiment, only four arms (e.g., with two on each side of the frame) may be required to traverse underneath of a rail vehicle or for a rail vehicle to traverse overtop the vehicle due to the staggered nature of the articulatable arms, for example.

In some instances, as shown in FIGS. 5 and 6, each arm is positioned directly across from a corresponding arm on the other side of the frame. Alternatively, the articulatable arms on one side of the frame may be staggered relative to the arms on the other side of the frame. The articulatable arms may positioned in an alternating pattern or a zigzag pattern with respect to the frame.

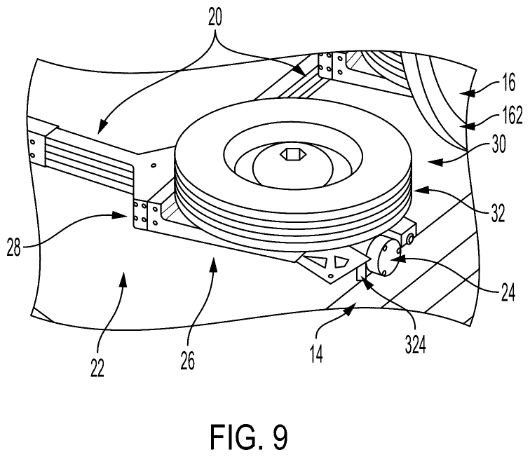

FIG. 14 illustrates the vehicle positioned on railway rails with wheels of a railcar positioned on the railway rails. As discussed in greater detail below, each articulatable arm may include a support element, or flanged wheel connected to the frame by the articulatable arm. In a first configuration of the articulatable arm, the flanged wheel is engaged with one of the rails of the railway. In one embodiment, when one or more than one flanged wheel is engaged with the rail of the railway, the vehicle can be driven along the railway when the flanged wheel is rotated about its respective rotation axis by its respective motor. In one embodiment, one or more than one of the flanged wheels engage the top surface, or running surface, of the rail of the railway in the first configuration. In an alternative embodiment, one or more than one of the flanged wheels engage the foot portion of the rail of the railway. As the vehicle approaches the wheels of the railcar, each of the articulatable arms is that can be actuated, for example sequentially, to move the flanged wheels out of the path of the railcar and permit the vehicle to pass along the railway rail underneath the railcar.

The vehicle may be stationary while the railcar moves toward and traverses across and over the vehicle. Alternatively, the railcar may be stationary while the vehicle moves toward and traverses across and under the railcar. Alternatively, the vehicle and the railcar may both be moving along the rail of the railway in the same direction, or opposite directions, where one traverses the other. In any event, the articulatable arms are that can be actuated to move the flanged wheels out of the path of the wheels of the railcar to permit non-disruptive movement of the vehicle and the railcar along the rail of the railway while providing support to the vehicle to remain supported on the rail of the railway.

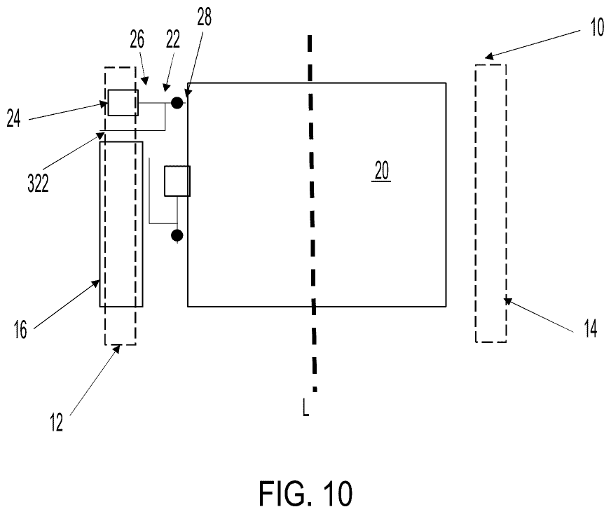

Referring now to FIG. 15, each articulatable arm may include a first joint portion 122 attached to the frame and a second joint portion 124 rotatably attached to the first joint portion about an articulation axis AA. In one embodiment, the first joint portion and the second joint portion are rotatably attached by an articulation pin 127. Further, the flanged wheel is rotatably attached to the second joint portion such that the flanged wheel is rotatable relative to the second joint portion, as well as the first joint portion and the frame, about a rotation axis RA. The articulatable arm may include a motor 126 fixed to the second portion with a rotary element of the motor attached to the flanged wheel such that the motor is that can drive the flanged wheel about the rotation axis RA relative to the second joint portion.

Further to the above, the articulatable arm may include an actuator 128 positioned intermediate the first joint portion and the second joint portion. In other embodiments, the arm may include a motor or other propulsive device. In one embodiment, the actuator is attached to the first joint portion with a rotatable portion of the actuator, such as an off centered pin, attached to the second joint portion. The actuator is that can rotate the second joint portion and the flanged wheel relative to the first joint portion and the frame about the articulation axis AA.

Alternatively, the motor can be fixed to the frame. The actuator may be powered by the motor or a separate motor. In an embodiment, the actuator acts against a biasing member or spring that can return the second joint to an unarticulated position absent an actuation force.

A plane of articulation about the articulation access is perpendicular to a plane of rotation about the rotation axis RA of the flanged wheel. Accordingly, the plane of articulation is a horizontal plane parallel to the ground. Alternatively, the articulatable arm may be attached to the frame ninety degrees from the orientation shown in FIG. 15 such that the articulation axis AA is parallel to the ground and the plane of articulation is perpendicular to the ground. In an embodiment, the articulatable arm may be attached to the frame in a manner that causes the plane of articulation to define an angle with the ground in a range of from about 0 degrees to about 90 degrees.

Each flanged wheel of each articulatable arm of the plurality of arms is independently and/or selectively actuatable between the engaged position and the disengaged position. Alternatively, two or more of the flanged wheels, as a pair, can be synchronously actuated between the engaged position and the disengaged position.

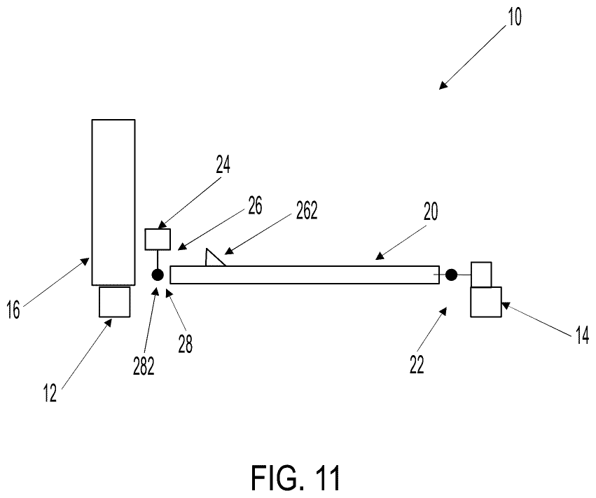

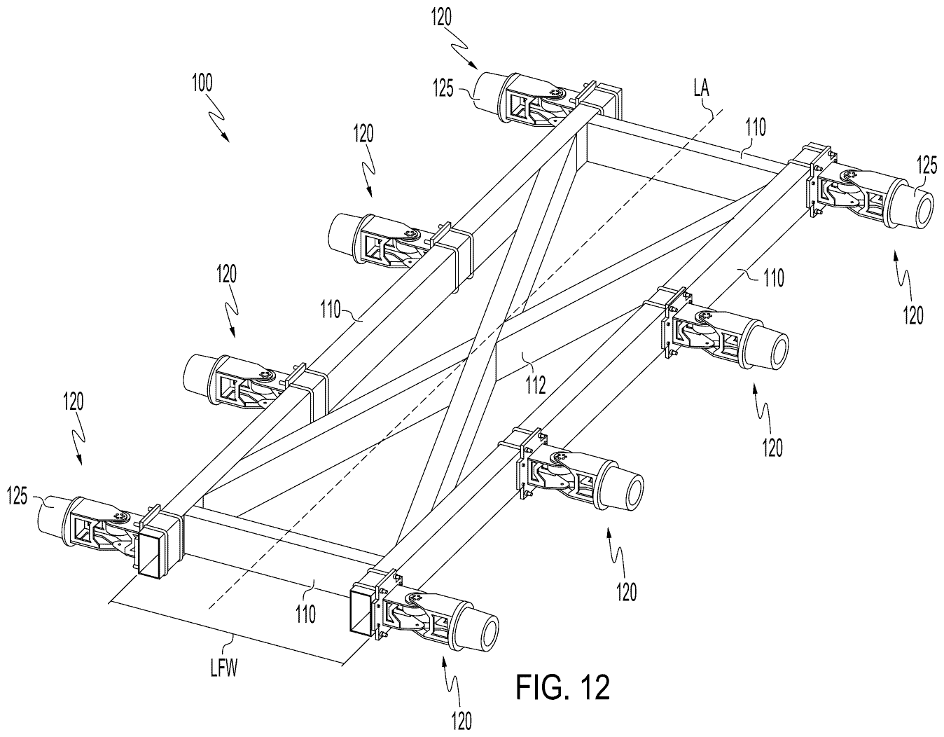

Referring to FIGS. 16-18, one of the articulatable arms is illustrated in various orientations. Specifically, FIG. 17 illustrates the articulatable arm in an unarticulated orientation, in the first configuration, with the flanged wheel in the engaged position resting on the top portion, or resting surface, of the rail of the railway. When the flanged wheel is in the engaged position, the first joint portion and the second joint portion of the articulatable arm are aligned, or substantially aligned, with each other as shown in FIG. 17. In the engaged position, the flanged wheel can provide tractive effort onto the resting surface of the rail in response to an actuation of the motor mounted to the second joint portion of the articulatable arm. In an alternative embodiment, one or more than one of the flanged wheels rests on the foot portion on the inside of the rail of the railway when the articulatable arm is in the unarticulated orientation, in the first configuration, with the flanged wheel in the engaged position. In this engaged position, the flanged wheel can provide tractive effort onto the foot portion of the rail in response to an actuation of the motor mounted to the second joint portion of the articulatable arm.

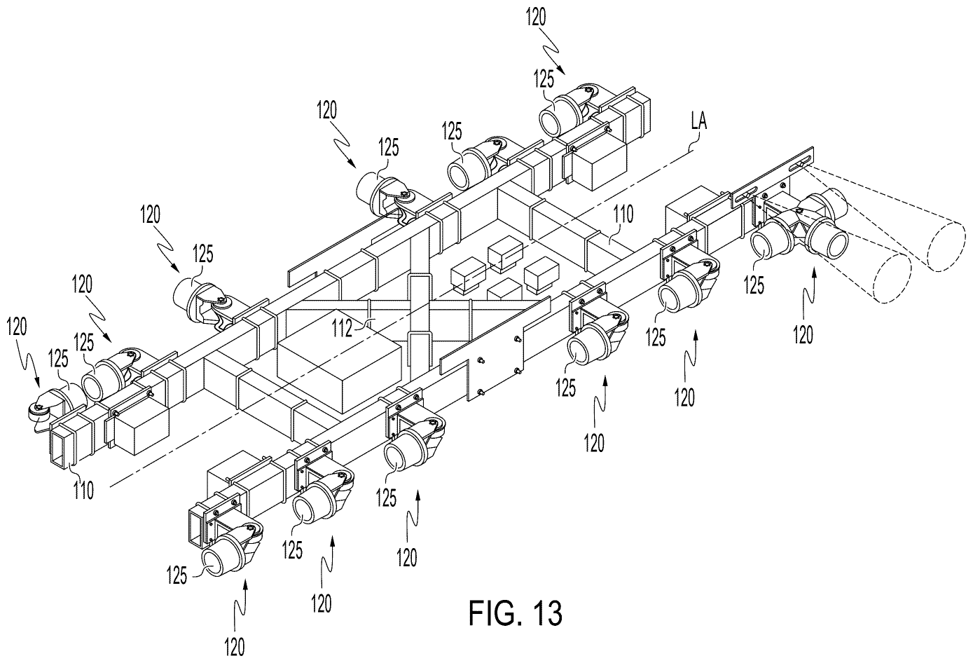

FIGS. 16 and 18 illustrate the articulatable arm in a second configuration with the flanged wheel disengaged from the rail of the railway. In FIGS. 16 and 18, the articulatable arm has been rotated away from the rail of the railway in opposite directions. In FIG. 16, the flanged wheel has been rotated in a first rotational direction FRD from the unarticulated orientation (FIG. 17) to a first articulated orientation. Conversely, in FIG. 18, the flanged wheel has been rotated in a second rotational direction SRD, opposite the first rotational direction FRD, from the unarticulated orientation (FIG. 17) to a second articulated orientation. The first and second articulation orientations are ninety-degree articulation orientation, in opposite directions. Alternatively, the first and second articulation orientations can define any angle suitable to disengage the flanged wheel from the rail to clear the wheel of the railcar. In some aspects, the angle is selected from a range of about 30 degrees to about 90 degrees, for example.

In various aspects, the flanged wheel of one or more than one of the articulatable arms can be drivingly rotated about its respective rotation axes RA in both the first configuration and the second configuration. In such instances, when the flanged wheel is transitioned from a disengaged position (e.g., FIG. 16 or 18) to the engaged position (e.g., FIG. 17), the rotation of the flanged wheel about axis RA may help reengage the flanged wheel with the rail of the railway.

As discussed above, the vehicle may be stationary with the railcar passing by the vehicle. When the vehicle is stationary, the flanged wheels are not actively rotating about their respective rotation axes. As such, when the articulatable arm actuates to move the flanged wheel out of the path of the wheel of the railcar, the flanged wheel may be actively braked by the motor of the articulatable arm to prevent the vehicle from moving along to the railway. In another aspect, the flanged wheels may be free to rotate about their respective rotation axes even when the vehicle is stationary (e.g., the flanged wheels are not being actively braked or actively rotated by their respective motors).

Further to the above, in one embodiment, the flanged wheels may be conical in shape, e.g. tapering smaller further away from the frame. In such instances, the conical shape can provide a ramping effect to help the flanged wheel reengage the rail of the railway when transitioning from the second configuration to the first configuration.

As discussed above, the articulatable arm may be attached to the frame ninety degrees from the orientation shown in FIG. 15. In such instances, the actuator of the articulatable arm can be actuated with one or more than one of the flanged wheels in the engaged position to lift the frame of the vehicle relative to the rail of the railway. When some, if not all, of the articulatable arms are actuated in this manner, the frame of the vehicle can be lifted up high enough to clear street crossings, railway switches, or other obstacles in between the rails of the railway. Further, n one embodiment, the articulatable arm can be actuated with the flanged wheel in the engaged position to drop the frame of the vehicle down in between the rails of the railway to avoid low hanging portions of a railcar above the frame of the vehicle, for example. In one embodiment, actuation in this manner may be utilized to completely disengage the flanged wheels of the vehicle from the rails to allow the entirety of the vehicle to be positioned below the resting surface of the rails of the railway.

Further to the above, a linear actuator may be positioned between one or more than one of the articulatable arms and the frame of the vehicle. In one embodiment, the linear actuator is mounted to the frame with an actuatable portion attached to the articulatable arm. In such instances, the linear actuator can be actuated to move the entirety of the articulatable arm up and down relative to the frame (i.e., orthogonal to the longitudinal axis of the frame). In various aspects, the linear actuator permits the frame of the vehicle to be raised up or down relative to the rails of the railway to avoid objects that may be in the path of the vehicle. For example, the linear actuator may be used to lift the frame of the vehicle high enough to clear street crossings, railway switches, or other obstacles in between the rails of the railway. Moreover, the linear actuator may be used to drop the frame down in between the rails of the railway to avoid a low railcar, for example.

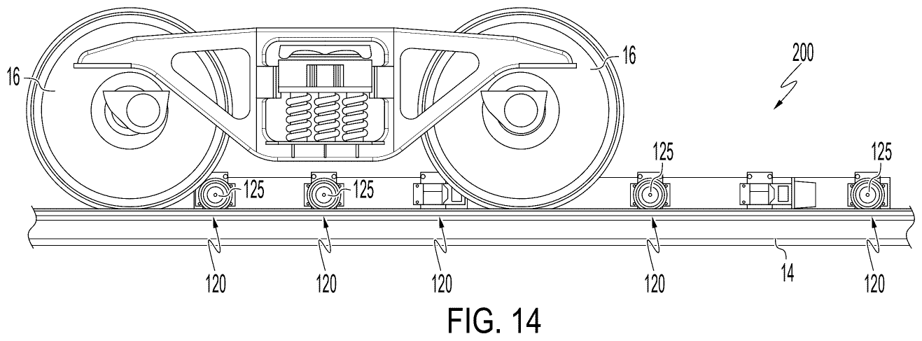

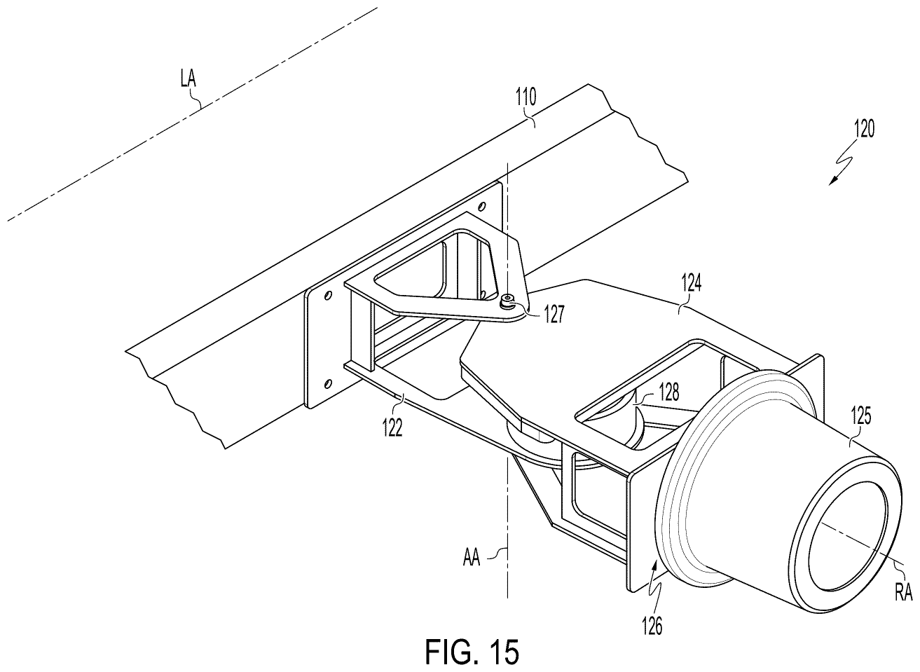

In one embodiment, each of the articulatable arms is that can be actuated to move the flanged wheel from the engaged position toward the disengaged position in a direction that is away from the wheel of the railcar no matter the relative movement directions between the vehicle and the wheel. For example, referring to FIG. 19, when the vehicle approaches a stationary wheel from left direction LD, the flanged wheels on either side of the frame can be rotated out of the path of the wheel of the railcar in a direction that is away from the wheel of the railcar. Similarly, if the rail vehicle wheel approaches the stationary vehicle from the right direction RD, the flanged wheels on either side of the frame can be rotated out of the path of the wheel of the railcar in a direction that is away from the wheel of the railcar. Similarly, the rotation direction is away from the rail vehicle wheel when the vehicle approaches a stationary railcar wheel from the right direction RD or when the rail vehicle wheels approach a stationary vehicle from the left direction LD, see FIG. 20.

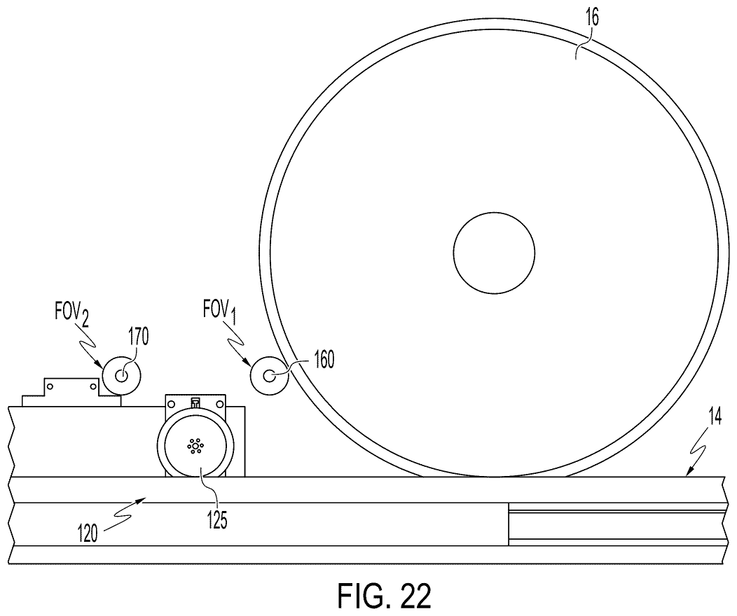

In various aspects, the direction of rotation of each of the flanged wheels may be away from the wheels of the railcar when both the vehicle and railcar wheels are moving along the rail of the railway relative to each other. In one embodiment, the direction of rotation of the flanged wheel being away from the wheel of the railcar may provide additional time for actuation of the articulatable arm to occur to prevent the flanged wheel from interfering with the wheel of the railcar, e.g., as compared to the flanged wheel rotating toward an approaching wheel of the railcar, or vice versa. Accordingly, the direction of rotation can be selectively determined by a control circuit (FIG. 27) to increase the time available for actuation of the articulation arm to move the flanged wheel away from the rail without, or with minimal, interference with the wheel of the railcar.

In use, when the articulatable arm approaches a wheel of a rail vehicle, or vice versa, the actuator of the articulatable arm is actuated to transition the flanged wheel of the articulatable arm from an engaged position (e.g., FIG. 17) to a disengaged position (e.g., FIG. 16 or 18). Each articulatable arm may be selectively (e.g., sequentially) actuated as the oncoming wheel is detected. In various aspects, while one articulatable arm is actuated to its second configuration to avoid the wheel of the railcar, the remaining articulatable arms can remain in their first configurations with the flanged wheels engaged with the rail to support the vehicle on the rail of the railway. In one embodiment, the frame of the vehicle is positioned the same vertical distance relative to the pair of rails of the railway as each of the articulatable arms are selectively (e.g., sequentially) transitioned between the first configuration and the second configuration as the vehicle passes underneath the railcar, or as the railcar passes overtop the vehicle.

In one embodiment, the frame of the vehicle may sag slightly in the region of two opposing articulation arms when the two opposing articulation arms are moved into their respective second configurations at the same time. In such instances, the other articulations arms, in their first configurations, support the vehicle so that the frame does not fall in between the rails to enable the two opposing flanged wheels to re-engage the rails of the railway once the wheel of the railcar passes by. In the event that the frame sags slightly in the region of opposing articulation arms in their second configurations, the flanged wheel of each articulation arm may be drivingly rotated about their respective rotation axes to assist in re-engaging the rail of the railway when the articulatable arm is moved from the second configuration back into the first configuration. Moreover, the flanged wheels may be conical in shape which can aid the flanged wheel to reengage the rail of the railway when the articulatable arm is moved from the second configuration to the first configuration.

In various aspects, the actuation of the actuator may be initiated by a sensor, or other detection system, which detects the presence of a wheel, or wheels, of a railcar in the path of the flanged wheel in close proximity to the flanged wheel, as discussed in greater detail below.

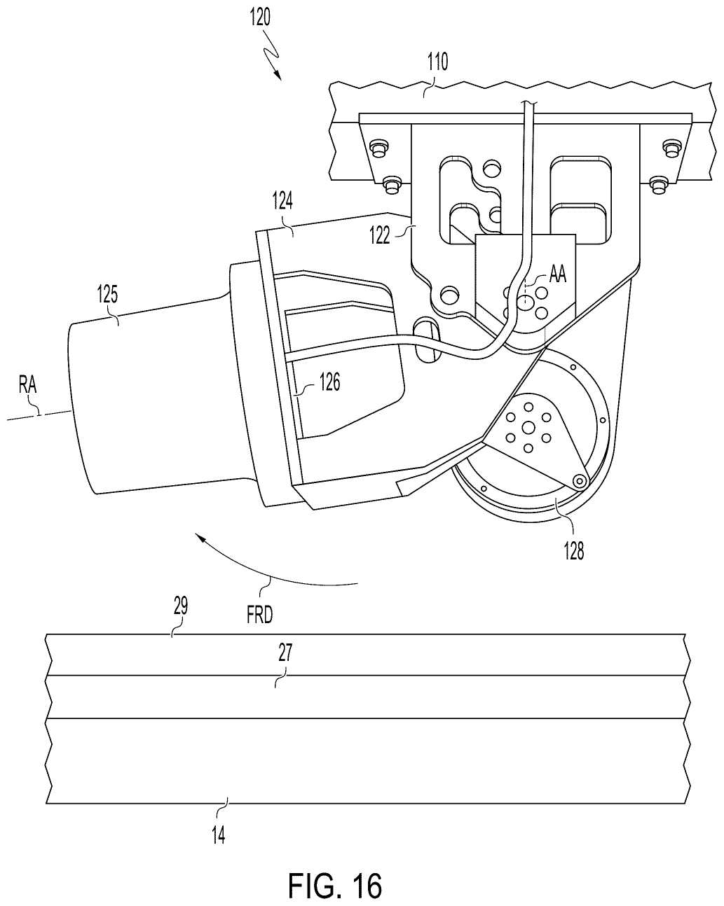

In order to initiate the actuation of the articulatable arms, the vehicle may employ one or more sensors to detect the presence of a nearby wheel on the rail of the railway. For example, a sensor system 150 may include a first sensor 160 and a second sensor 170. The sensor system may mount to the frame on either side of the articulatable arm, e.g., on either side of the flanged wheel in the engaged position as shown in FIGS. 21-26. Each articulatable arm may have a dedicated sensor system. In any event, the first sensor that can detect, or sense, objects within a first field of view FOV₁ and the second sensor is that can sense objects within a second field of view FOV₂. The first sensor, the second sensor, and the actuator of the articulatable arm are in signal communication with each other, for example.

A suitable control circuit 180 (FIG. 27) may include a memory 182 and one or more processors 184 and may execute instructions stored in the memory. In one embodiment, the control circuit may be in signal communication with each of the sensor systems and with each of the actuators of the articulatable arms as shown in the schematic of FIG. 27. In one embodiment, the control circuit may be in signal communication with each of the sensor systems, with each of the actuators of the articulatable arms, and with the linear actuator. In such instances, the control circuit may receive and interpret sensor input, based at least in part on the sensor input may identify an obstacle, and may respond by selectively causing the linear actuator to move the frame to avoid an obstacle.

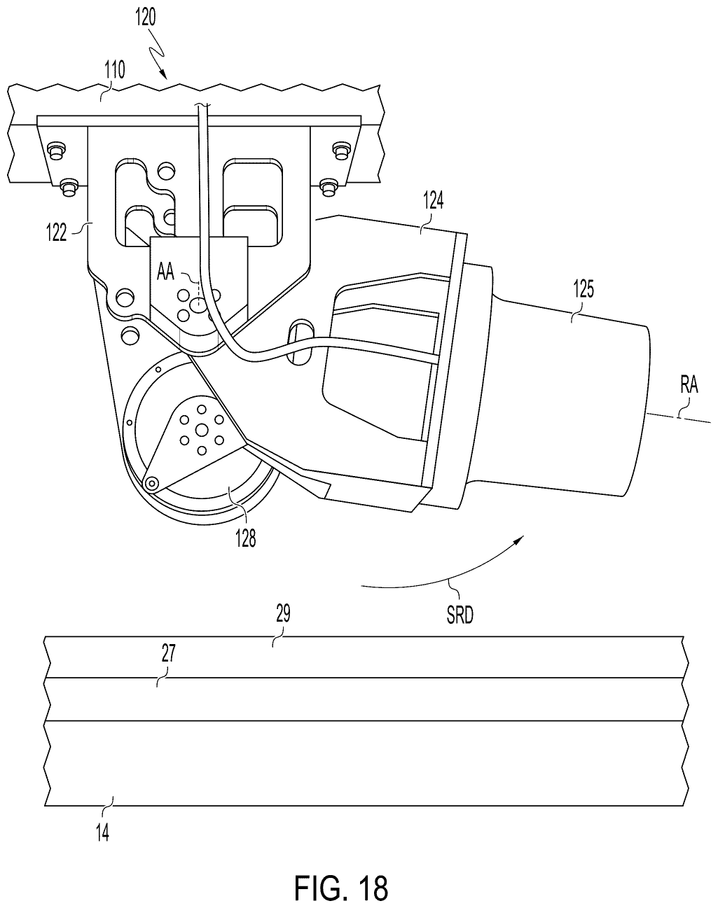

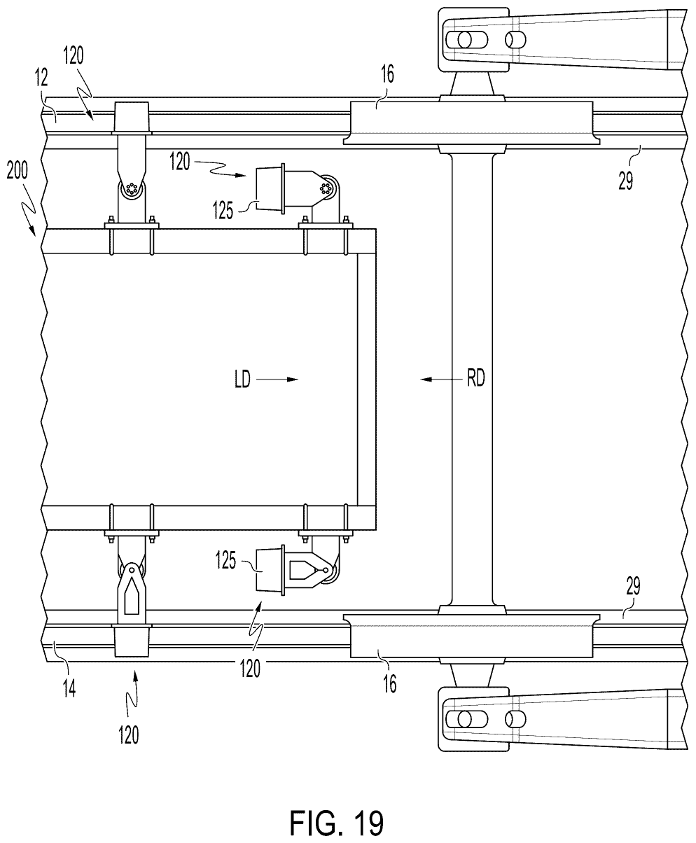

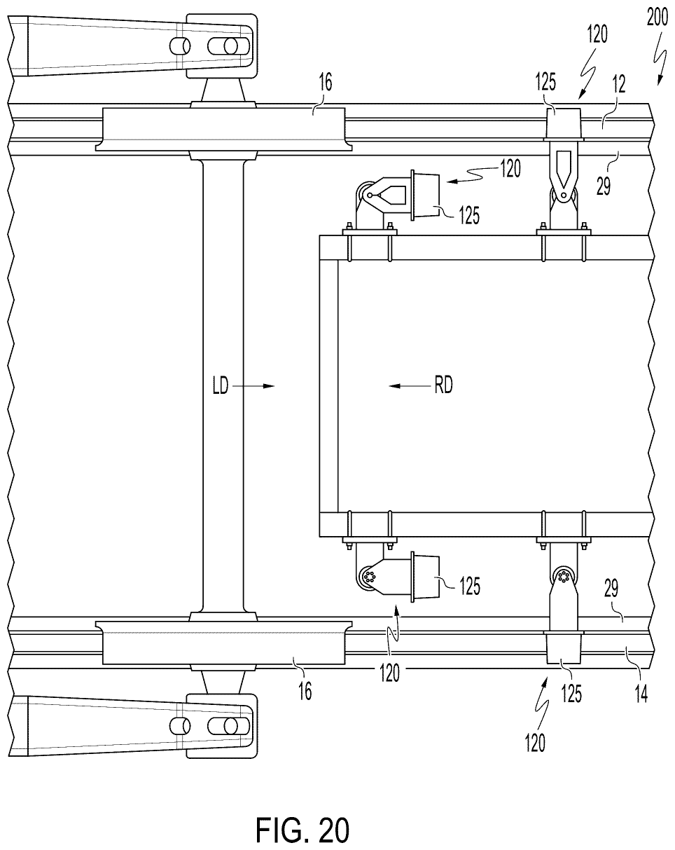

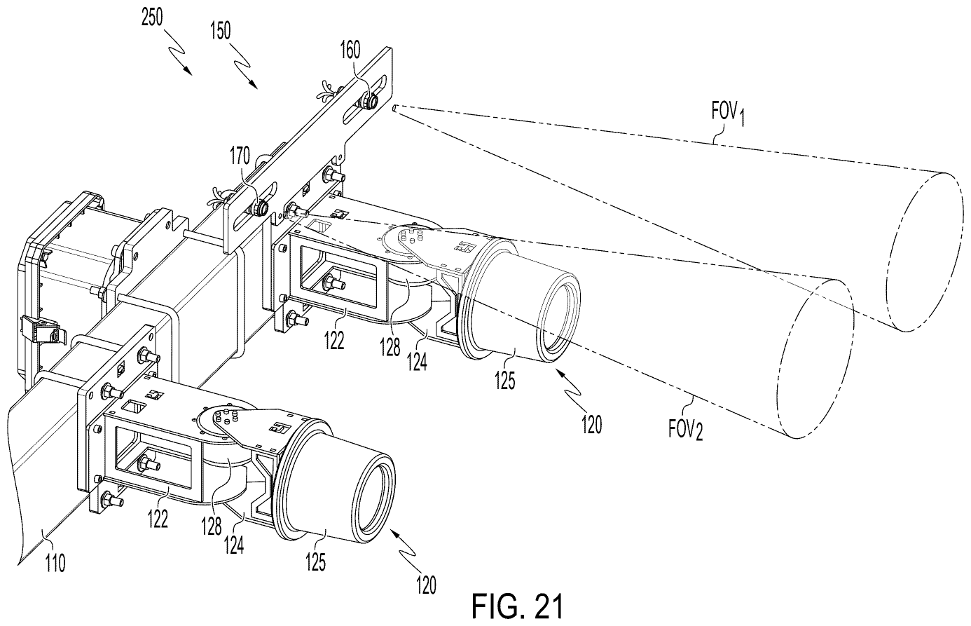

Referring to FIG. 23, when neither the first sensor nor the second sensor detects an obstruction, such as a wheel of a railcar in the path of a flanged wheel 125 of the vehicle, the flanged wheel is in the engaged position. Referring to FIG. 24, when an object, such as the wheel of the railcar initially enters the first field of view FOV₁ of the first sensor, the first sensor sends a signal to the control circuit which in turn actuates the actuator of the articulatable arm to move the flanged wheel from the engaged position to the disengaged position such that the flanged wheel disengages the rail of the railway and moves out of the path of the wheel of the railcar. Further, after the first sensor initially detects the wheel, the second sensor is to detect the wheel upon further movement of the wheel along the rail of the railway and into the second field of view FOV₂, as shown in FIG. 25. When the second sensor detects the wheel of the railcar after the first sensor, the second sensor sends a signal to the control circuit which in turn directs the actuator to maintain the flanged wheel in the engaged position. Upon the second sensor no longer detecting the wheel of the railcar within the second field of view FOV₂, as shown in FIG. 26, the second sensor sends a signal to the control circuit which is that can actuate the actuator to transition the flanged wheel from the disengaged position to the engaged position to reengage the rail of the railway, as shown in FIG. 26.

In various aspects, the size of the first field of view FOV₁ and the second field of view FOV₂ are selected to give the flanged wheel ample time to be actuated out of the way of the wheel of the railcar upon the first sensor initially detecting the wheel of the railcar, and selected to ensure that the wheel of the railcar is clear of the rotating path of the flange wheel prior to transitioning the flanged wheel back into the engaged position to ensure the flanged wheel does not interfere with the wheel of the railcar passing by.

In instances where the second sensor is the first to detect an obstruction, such as the wheel of the railcar, the control circuit can move the flanged wheel out of the way of the wheel of the railcar in the same manner as described above, albeit in reverse due to the second sensor detecting the wheel of the railcar first. Moreover, the sensor system will work in a similar manner to initiate actuation of the flanged wheels when the vehicle is moving along the railway and the wheels of the railcar on the railway rail are stationary. The sensor system will work in a similar manner to actuate the flanged wheels when both the vehicle and the wheel of the railcar are moving along the railway.

In one embodiment, a single sensor may be used having a field of view that is large enough to initially detect the wheel within the field of view in order to give the flanged wheel of the vehicle ample time to rotate to the disengaged position and to initiate the transition of the flanged wheel from the disengaged position back into the engaged position once the single sensor no longer detects the wheel of the railcar within its field of view.

In alternative embodiments, only a subset of the flanged wheels is associated with sensors, and the control circuit is that can perform a hybrid of time-based articulation decisions and sensor-based articulation decisions. The sensors can be limited to one or both of the flanged wheels at the front end of the vehicle Additionally, or alternatively, the sensors can be limited to one or both of the flanged wheels at the back end of the vehicle. The intermediate flanged wheels may lack direct sensor support. The control circuit may determine when to articulate the articulation arms to move the intermediate flanged wheels away from the rail based on the time from receipt of an input sensor associated with another flanged wheel (front/end) assuming a significant change in speed is not detected.

To ensure a sufficient number of engaged flanged wheels are available to support the vehicle on the rail of the railway, a control circuit (FIG. 27) may execute an articulation sequence or pattern. The control circuit may control the instance and direction of articulation of the articulation arms based on sensor input from a sensor system 150 (FIG. 27), the sensor input indicative of upcoming wheel interfaces, for example. In one aspect, the decision to articulate one of the articulation arms, for example in response to a sensor input, can be conditioned upon detecting a sufficient number of engaged flanged wheels, or articulation arms in unarticulated orientation, to support the vehicle on the rail of the railway.

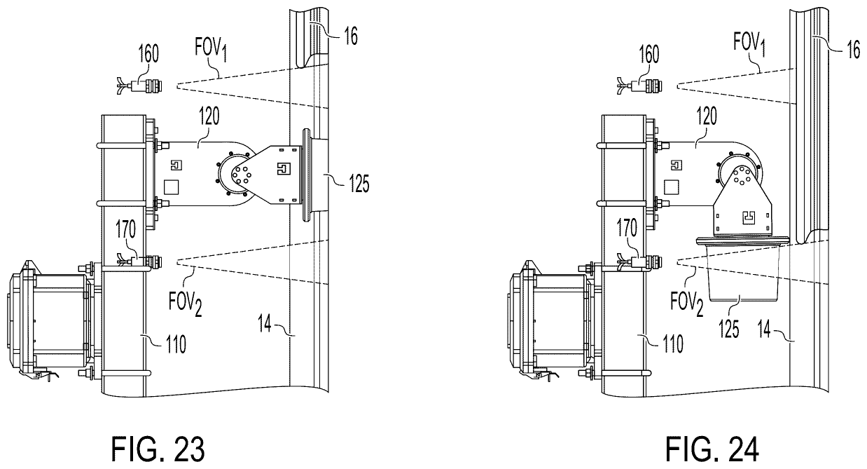

FIG. 28 illustrates a vehicle 300 for travelling along a rail of a railway. The vehicle in FIG. 28 is similar in some respects to the vehicles shown in FIGS. 12 and 13, and is capable of traversing underneath of a rail vehicle and/or permitting a rail vehicle to traverse overtop it. The vehicle may include a frame 310 and a plurality of connection elements, or actuatable arms 320 extending from the frame. The frame defines a lateral frame width that is less than the distance between a pair of rails of a railway, for example. In various aspects, the frame has cross bracing to provide rigidity to the frame. The cross bracing provides mounting locations for various railway maintenance components, as discussed in greater detail elsewhere herein.

The vehicle may include ten actuatable arms with five actuatable arms positioned on either side of a longitudinal axis defined by the frame. In another embodiment, a vehicle can include plural sets of arms. These sets may be directly opposed to each other in one embodiment and may be offset relative to each other in other embodiments.

In some instances, as shown in FIG. 28, each arm is positioned directly across from a corresponding arm on the other side of the frame. Alternatively, the actuatable arms on one side of the frame may be staggered relative to the arms on the other side of the frame. The actuatable arms may positioned in an alternating pattern or a zigzag pattern with respect to the frame.

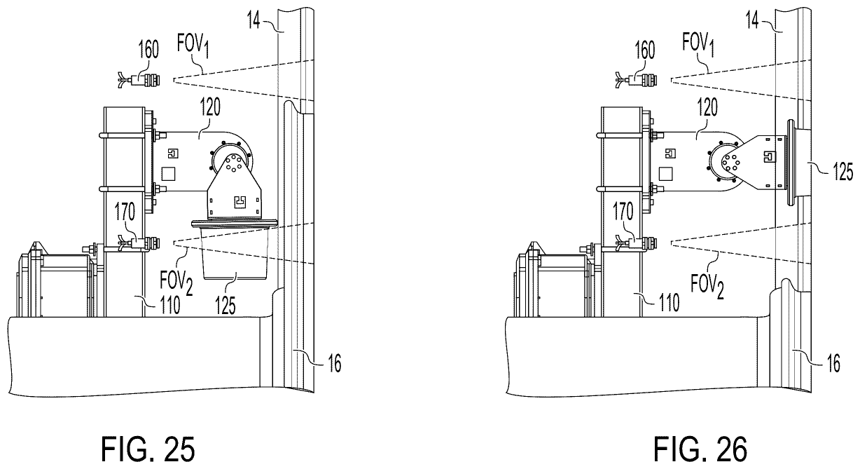

FIG. 29 illustrates an enlarged view of one of the actuatable arms of the vehicle. Each actuatable arm may include a first connector 340 attached to the frame and a second connector 350 extending from the first connector and movable relative to the first connector. The actuatable arm further may include a support element, or flanged wheel 330, and a guide shoe 360 which are mounted to the second connector. Further, the actuatable arm may include a pair of compression springs 370 mounted between the first connector and the second connector. The actuatable arm further may include a direct drive motor 335 for actuating the flanged wheel relative to the frame about a rotation axis RA.

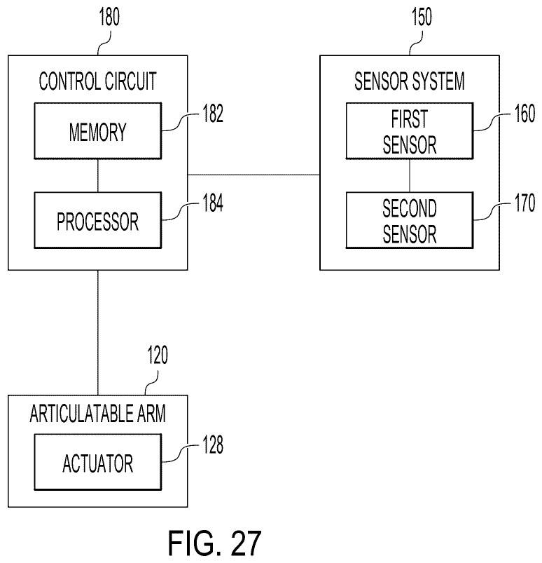

Referring primarily to FIGS. 30-35, In one embodiment, as the vehicle approaches a wheel of a railcar from a first direction FD, each of the guide shoes of the actuatable arms are that can sequentially engage the wheel to move the flanged wheels and guide shoe out of the path of the wheel to permit the vehicle to pass along the rails of the railway underneath the railcar. The vehicle may be stationary while the railcar moves toward and traverses the vehicle. Alternatively, the railcar may be stationary while the vehicle moves toward and traverses the railcar. Alternatively, the vehicle and the railcar may both be moving along the rail of the railway in the same direction, or opposite directions, where one traverses the other.

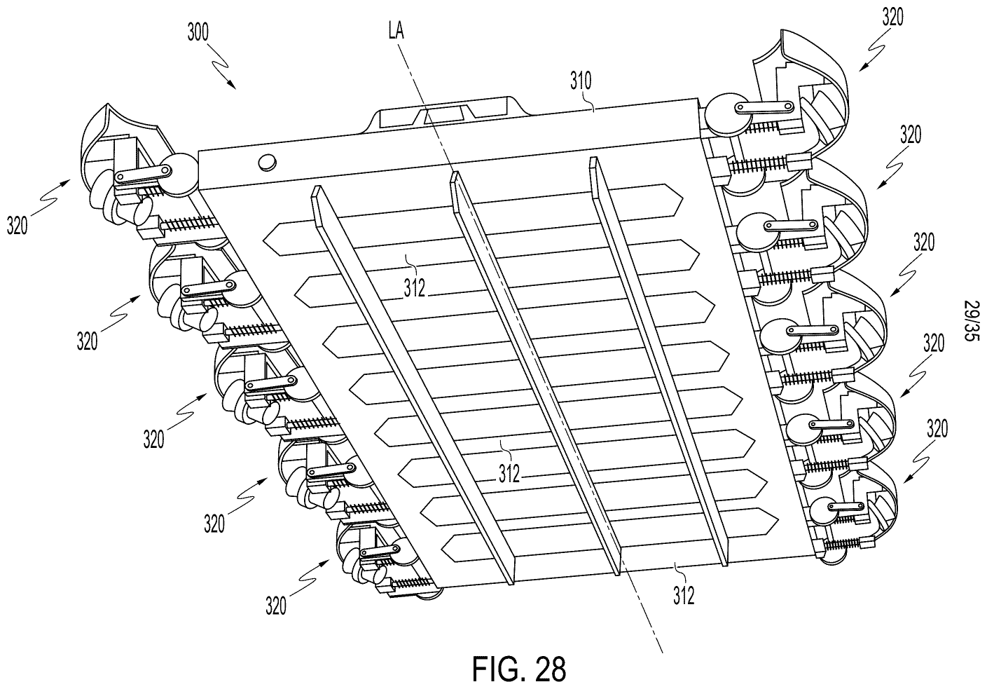

Referring to FIGS. 30 and 31, when the guide shoe is not engaged with the wheel of the railcar, the actuatable arm is in a first configuration where the flanged wheel is engaged with the rail of the railway. In the engaged position, the flanged wheel is permitted to be rotated about its rotation axis by its respective motor to produce tractive effort onto the rail of the railway. As such, when the flanged wheel is in the engaged position, the vehicle can be driven along the rails of the railway. In one embodiment, the biasing force of the compression springs biases the second connector away from the first connector and, thus, retains the flanged wheel in the engaged position.

Further to the above, in the illustrated embodiment, the flanged wheel rests on the top portion of the rail of the railway as shown in FIGS. 30 and 31. In an alternative embodiment, in the engaged position, the flanged wheel rests on the foot portion of the rail of the railway.

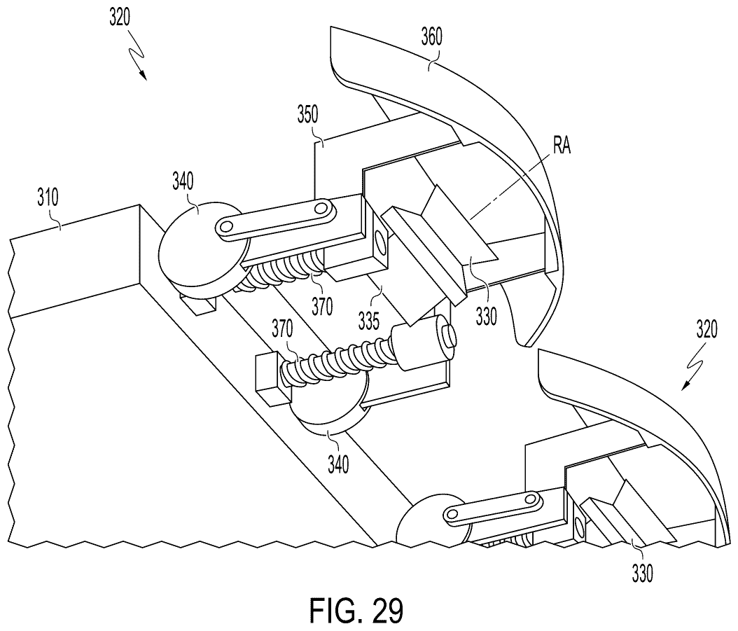

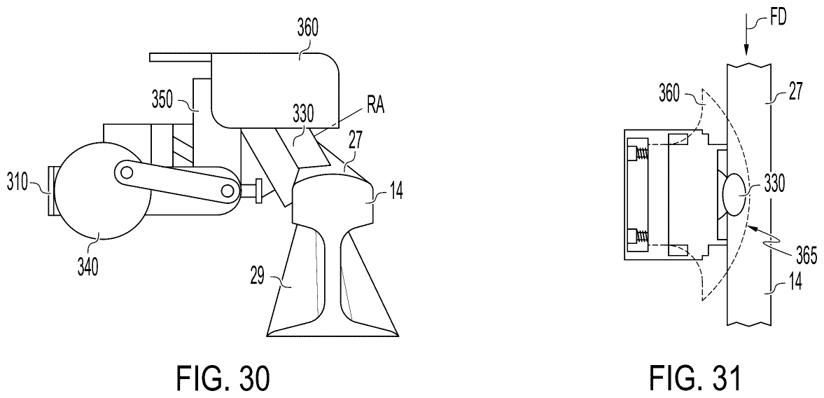

Further to the above, when the guide shoe and the wheel of the railcar initially engage one another, the actuatable arm is transitioned from the first configuration into a second configuration, as shown in FIGS. 32 and 33. As the guide shoe of the actuatable arm and the wheel of the railcar engage each other, the compression springs are compressed to permit the second connector and, thus, the flanged wheel to move away from the rail toward the frame of the vehicle and, thus, to disengage the rail.

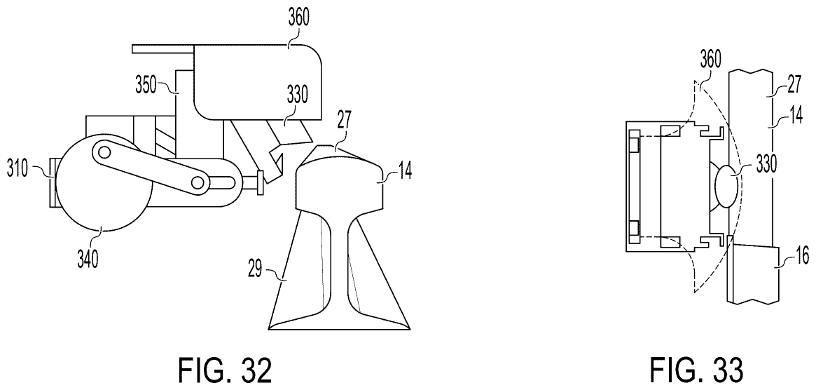

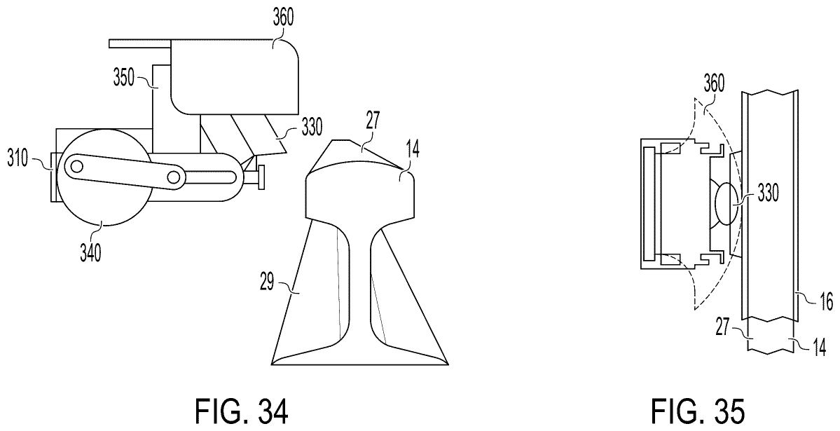

Further to the above, in response to relative movement between the actuatable arm and the wheel of the railcar, the guide shoe may be moved further away from the rail toward the frame of the vehicle to retain the actuatable arm in the second configuration with the flanged wheel disengaged from the rail of the railway as shown in FIGS. 34 and 35. In one embodiment, the guide shoe may remain in contact with the wheel of the railcar until the wheel passes completely by the guide shoe. Upon the wheel of the railcar moving clear of the guide shoe, the compression springs transition the actuatable arm from the second configuration back into the first configuration to reengage the flanged wheel with the rail of the railway, i.e., the same configuration shown in FIGS. 30 and 31.

Referring still to FIGS. 30-35, in one embodiment, the guide shoe defines an arcuate outer surface 365 that permits the wheel of the railcar to gradually engage the guide shoe to transition the actuatable arm between the first configuration (FIG. 30) to the second configuration (FIG. 32). In one embodiment, the guide shoes of the vehicle are replaceable. In any event, each of the guide shoes of the vehicle are that can engage the wheel of the railcar to sequentially transition each actuatable arm, on both sides of the vehicle, between the first configuration and the second configuration to permit the vehicle to pass underneath the railcar.

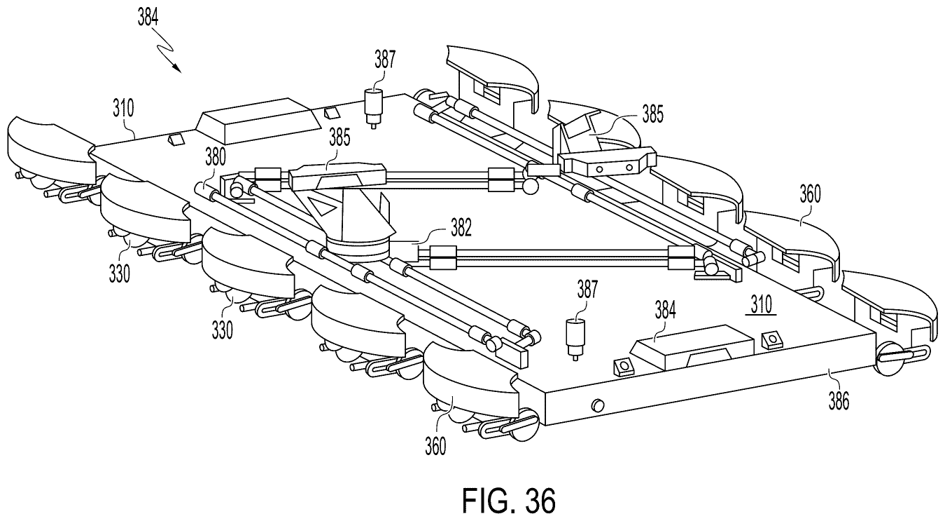

The following description discusses a number of components that can perform various maintenance and/or operational tasks while the vehicle is underneath a railcar. As shown in FIG. 36, the vehicle may include a plurality of manipulators 380 attached to the frame. Suitable manipulators can be high speed multi-axis manipulators that lay flat when the vehicle passes underneath of a railcar and then are that can be actuated to rise up to perform multiple tasks such as, for example, maintenance tasks including manipulating air valves. In one embodiment, the manipulators are used to connect air couplers. In one embodiment, the manipulators include belt driven linear actuators.

In various aspects, the manipulators may have an end effector attached thereto. The end effectors are that can perform operations and/or maintenance on railway cars and systems. Suitable end effectors may have one or more of an integrated yaw drive, a grip for air valve or air hose gladhand, a camera, lighting, a microphone, pressure sensors, replaceable grip pads, sweep rods, range finders, and the like, for example.

In one embodiment, the vehicle further may include a microphone 382. The microphone may be attached to the frame portion. The microphone may be used to detect and to locate or pinpoint leaks in railcar air systems.

In one embodiment, the camera 384 may be a stereo camera. The stereo camera may have a first camera mounted at the front and a second camera mounted at the rear of the vehicle. This arrangement may be suitable for navigation clearance sensing. In one embodiment, the vehicle may include stereo cameras in the middle of the frame for imaging the underside of railcars, imaging railcar couplings, and/or imaging air valves. In one embodiment, additional cameras may be mounted to the manipulators for precision sensing. In one embodiment, the cameras are robust multimodal cameras that can provide 2D and 3D data for navigation and manipulation tasks. In one embodiment, the cameras can validate that there is open or free space for the vehicle and the manipulators to move within.

In one embodiment, the vehicle may include a light, such as an LED light, attached to the frame. In one embodiment, the vehicle may include one LED light mounted at the front and one mounted at the rear of the vehicle. In various aspect, the LED lighting is electrically synchronized with the cameras attached to the frame. In one embodiment, the vehicle may include a status light 387 for indicating the status of the vehicle. For example, when the light is lit in a first color, the vehicle may be in an error state and when the light is lit in a second color, the vehicle may be in an autonomous state.

A suitable control circuit, or controller, may include an integrated circuit, a general-purpose computing device, one or more processers, a memory device (e.g., forms of random access memory), a communications device (e.g., a modem, blue-tooth, cellular communications, satellite device), a communications switch, or optical-electrical equipment).

In one embodiment, the control circuits, controllers or systems described herein may have a local data collection system deployed and may use machine learning to enable derivation-based learning outcomes. The control circuits may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the control circuit may use evolution strategies techniques to tune various parameters of the artificial neural network. The control circuits may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models is obtained, they may be evaluated on their performance using a determined success metric. The best model is selected, and the vehicle control circuit executes that plan to achieve the desired input data to mirror the predicted best outcome scenario. Additionally, the success metric may be a combination of the optimized outcomes, which may be weighed relative to each other.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the examples, including the best mode, and to enable a person of ordinary skill in the art to practice the examples, including making and using any devices or systems and performing any incorporated methods. The claims define the patentable scope of the disclosure and include other examples that occur to those of ordinary skill in the art. Such other examples are within the scope of the claims if they have structural elements that do not differ from the literal language of the claims, or if they include equivalent structural elements with insubstantial differences from the literal language of the claims.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term “non-transitory computer-readable medium” refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

Software components described herein may be implemented using languages such as Python, Java, C++, or Perl. The corresponding software code may be stored on various computer-readable media, such as RAM, ROM, hard drives, or CD-ROMs. These media may be part of a single computational device or distributed across multiple devices within a networked system.

The term “control circuit” encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

The term “logic” refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An “algorithm” refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as “processing,” “computing,” “calculating,” or “determining” refer to operations carried out by computing systems or electronic devices, which manipulate data represented as physical (electronic) quantities within memory or registers.

Terms like “component,” “system,” and “module” refer to computer-related entities, whether hardware, software, or a combination thereof. One or more components may be described as “configured to,” “configurable to,” “operable/operative to,” “adapted/adaptable to,” or similar terms. Unless explicitly stated, these terms encompass components in both active and inactive states.

Unless stated otherwise, terms like “including” or “having” should be interpreted as open-ended (i.e., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the invention, and variations may be made by those skilled in the art. The accompanying claims define the invention's broadest legal scope within its spirit and scope.

What is claimed is:

1. A vehicle connection system, comprising:
a frame;
a lacing actuator configured to position a first coupler of a first hose in engagement with a second coupler of a second hose, wherein a first vehicle comprises the first hose and a second vehicle comprises the second hose;
a first guide coupled to the frame that is configured to collect the first hose responsive to movement of at least one of the frame or the first vehicle;
a second guide coupled to the frame that is configured to collect the second hose responsive to movement of at least one of the frame or the second vehicle;
a first grasper configured to receive the first hose from the first guide and deliver the first hose to the lacing actuator; and
a second grasper configured to receive the second hose from the second guide and deliver the second hose to the lacing actuator.

2. The system of claim 1, wherein the lacing actuator is further configured to couple the first coupler of the first hose and the second coupler of the second hose to define a conduit extending between the first vehicle and the second vehicles.

3. The system of claim 1, further comprising a first movement area defined by the frame and a second movement area defined by the frame, and the first grasper is movable along the first movement area to deliver the first hose to the lacing actuator, and the second grasper is movable along the second movement area to deliver the second hose to the lacing actuator.

4. The system of claim 3, wherein the frame defines a longitudinal axis, the first movement area is a first track, the second movement area is a second track, and the first track and the second track are laterally offset relative to the longitudinal axis.

5. The system of claim 1, wherein the first guide comprises first arms configured to lead the first hose towards the first grasper based on movement of the frame relative to the first vehicle in a first direction, and wherein the second guide comprises second arms configured to lead the second hose towards the second grasper based on movement of the frame relative to the second vehicle in a second direction different from the first direction.

6. The system of claim 1, further comprising a grasping sensor configured to detect that the first hose is received by first grasper.

7. The system of claim 1, further comprising a lacing sensor configured to detect engagement of the first coupler of the first hose with the second coupler of the second hose.

8. The system of claim 1, wherein, when coupled, the first hose and the second hose define a conduit for conveying a fluid between the first vehicle and the second vehicle, and the system further comprises a leak detection sensor configured to detect a parameter indicative of a leak of the fluid from the conduit.

9. The system of claim 1, wherein the first vehicle and the second vehicle are each railcars movable along rails of a railway, wherein the first hose and the second hose are each air brake hoses, and wherein the first coupler of the first hose and the second coupler of the second hose comprise gladhands.

10. The system of claim 9, wherein the frame is configured to move along the railway and below the railcars without interfering with wheels of the railcars.

11. The system of claim 10, further comprising a plurality of articulatable arms extending from the frame, each articulatable arm comprising:
a first joint portion attached to the frame;
a second joint portion rotatably attached to the first joint portion about an articulation axis;
a flanged wheel rotatably attached to the second joint portion such that the flanged wheel is rotatable relative to the second joint portion about a rotation axis;
a drive motor configured to rotate the flanged wheel about the rotation axis; and
an actuator configured to rotate the second joint portion and the flanged wheel relative to the first joint portion about the articulation axis to transition the articulatable arm between a first configuration where the flanged wheel is engaged with and rests upon a resting surface of one of the rails and a second configuration where the flanged wheel is disengaged from the rails, and each articulatable arm, or pairs of arms, of the plurality of articulatable arms is selectively actuatable between the first configuration and the second configuration.

12. A method, comprising:
moving a first guide relative to a first vehicle in a first direction to lead a first hose of the first vehicle toward a first grasper;
moving a second guide relative to a second vehicle, adjacent to the first vehicle, in a second direction that is different from the first direction to lead a second hose of the second vehicle toward a second grasper;
actuating the first grasper to deliver the first hose to a lacing actuator;
actuating the second grasper to deliver the second hose to the lacing actuator; and
actuating the lacing actuator to position a first coupler of the first hose in engagement with a second coupler of the second hose.

13. The method of claim 12, further comprising actuating the lacing actuator to couple the first coupler of the first hose and the second coupler of the second hose to define a conduit extending between the first vehicle and the second vehicle.

14. The method of claim 12, wherein the first guide and the second guide are coupled to a frame, and moving a first guide and moving a second guide comprises moving the frame that supports the first and second graspers; and, the frame defines a first track and a second track, and the first grasper is configured to move along the first track and the second grasper is configured to move along the second track.

15. The method of claim 14, wherein actuating the first grasper to deliver the first hose to the lacing actuator comprises at least moving the first grasper along the first track or articulating the first grasper to open or close at an end distal to the frame.

16. The method of claim 14, further comprising repeating the method of claim 12 with subsequent vehicles to form a vehicle system comprising plural coupled vehicles.

17. The method of claim 16, wherein the first vehicle and the second vehicle are each railcars movable along rails of a railway, and the first hose and the second hose are each air brake hoses, and the first coupler of the first hose and the second coupler of the second hose are gladhands.

18. The method of claim 17, wherein moving the frame relative to the vehicle system comprises moving the frame along the railway and below the railcars.

19. The method of claim 13, further comprising detecting, by a grasping sensor, that the first hose is received by the first grasper.

20. The method of claim 13, further comprising detecting, by a lacing sensor, engagement of the first coupler with the second coupler.

21. The method of claim 13, further comprising pressurizing a conduit defined by the first hose and the second hose; and detecting, by a leak detection sensor, a leak of the fluid from the conduit.

22. The method of claim 21, further comprising severing the conduit by disconnecting the first hose from the second hose.
